(19) United States
(12) Patent Application Publication
(10) Pub. No.: US 2026/0163283 A1
(43) Pub. Date: Jun. 11, 2026

(54) CONNECTOR, PARTNER CONNECTOR, AND CONNECTOR DEVICE

(71) Applicant: HIROSE ELECTRIC CO., LTD., Kanagawa (JP)

(72) Inventor: Kenta KUSAKA, Kanagawa (JP)

(21) Appl. No.: 19/181,426

(22) Filed: Apr. 17, 2025

(30) Foreign Application Priority Data
Apr. 22, 2024 (JP) 2024-068824

(51) Int. Cl. H01R 13/405; H01R 12/73

(52) U.S. Cl. CPC H01R 13/405; H01R 12/73

(57) ABSTRACT

Provided is a connector which includes: two first terminals; a second terminal disposed between the two first terminals; and a terminal holder holding the first terminals and the second terminal, in which each first terminal has a first contact portion, the first contact portion protrudes in one direction from the terminal holder, and is formed so as not to elastically displace, the second terminal has a second contact portion, and the second contact portion protrudes in the one direction from the terminal holder, and is formed elastically displaceably in a direction opposite to the one direction.

### CROSS-REFERENCE TO RELATED APPLICATION

This application claims priority from Japanese Patent Application No. 2024-068824 filed with the Japan Patent Office on April 22, 2024, the entire content of which is hereby incorporated by reference.

### BACKGROUND

### 1. Technical Field

The present disclosure relates to a connector, a partner connector, and a connector device.

### 2. Related Art

As a connector for electrically connecting boards, there has been known a connector including a plurality of terminals formed elastically displaceably and a housing holding the terminals and having a structure in which each terminal protrudes in one direction from the housing and pressed by a terminal of a partner connector upon connection with the partner connector to elastically displace in a direction opposite to the one direction. JP-A-2006-164682 describes one example of such a connector.

The connector (hereinafter may be referred to as an above-described connector) described in JP-A-2006-164682 is used in some cases as a connector for electrically connecting body-side and battery-side boards in small electric and electronic equipment such as a smartphone or a compact digital camera, for example. In this case, each of the above-described connector and a partner connector to be connected to such a connector is provided with three or more terminals, and two of these three or more terminals are power terminals and the remaining terminals are signal terminals. For example, the above-described connector is attached to the body-side board of the electric and electronic equipment, the power terminals and the signal terminals of the above-described connector are connected to a circuit of the body-side board, the partner connector is attached to the battery-side board, and the power terminals and the signal terminals of the partner connector are connected to a circuit of the battery-side board. By connecting the above-described connector and the partner connector to each other, the body-side board and the battery-side board are electrically connected to each other. Thus, upon operation of the electric and electronic equipment, a power-supply current can be applied from a battery to a body through the two power terminals provided for each of the above-described connector and the partner connector. When the electric and electronic equipment is connected to a commercial power supply to charge the battery, a charging current can be applied from the body to the battery through the two power terminals provided for each of the above-described connector and the partner connector. For example, a signal for monitoring the temperature of the battery, a signal for monitoring the remaining level of the battery, or the like can be transmitted between the body and the battery through the signal terminals provided for each of the above-described connector and the partner connector.

### SUMMARY

A connector according to an embodiment of the present disclosure includes: two first terminals; a second terminal disposed between the two first terminals; and a terminal holder holding the first terminals and the second terminal, in which each first terminal has a first contact portion, the first contact portion protrudes in one direction from the terminal holder, and is formed so as not to elastically displace, the second terminal has a second contact portion, and the second contact portion protrudes in the one direction from the terminal holder, and is formed elastically displaceably in a direction opposite to the one direction.

### BRIEF DESCRIPTION OF THE DRAWINGS

FIG. 1 is a view for describing electric and electronic equipment provided with a connector device of a first embodiment of the present disclosure;

FIG. 2 is an external view showing a connector, a partner connector, and the like according to the first embodiment of the present disclosure;

FIG. 3 is an external view showing a state of the connector and the partner connector according to the first embodiment of the present disclosure being connected to each other;

FIG. 4 is an external view showing the state of the connector of the first embodiment of the present disclosure as viewed from the front upper left side;

FIG. 5 is an external view showing the state of the connector of the first embodiment of the present disclosure as viewed from the back lower left side;

FIG. 6 is an external view showing the state of the connector of the first embodiment of the present disclosure as viewed from above;

FIG. 7 is a sectional view taken along cut line a-a in FIG. 6, which shows the state of the connector as viewed from the left side;

FIG. 8A is an external view showing the state of a power terminal of the connector of the first embodiment of the present disclosure as viewed from the front upper left side, FIG. 8B is an external view showing the state of the power terminal as viewed from the left side, FIG. 8C is a sectional view taken along cut line b-b in FIG. 8B, which shows the state of the power terminal as viewed from the front side, and FIG. 8D is a sectional view taken along cut line c-c in FIG. 8B, which shows the state of the power terminal as viewed from the front side;

FIG. 9A is an external view showing the state of a signal terminal of the connector of the first embodiment of the present disclosure as viewed from the front upper left side, FIG. 9B is an external view showing the state of the signal terminal as viewed from the left side, and FIG. 9C is a sectional view taken along cut line d-d in FIG. 9B, which shows the state of the signal terminal as viewed from below;

FIG. 10 is an external view showing the state of the partner connector of the first embodiment of the present disclosure as viewed from the front upper left side;

FIG. 11 is an external view showing the state of the partner connector of the first embodiment of the present disclosure as viewed from the back lower left side;

FIG. 12 is an external view showing the state of the partner connector of the first embodiment of the present disclosure as viewed from above;

FIG. 13 is a sectional view taken along cut line e-e in FIG. 12, which shows the partner connector as viewed from the left side;

FIG. 14A is an external view showing the state of a power terminal of the partner connector of the first embodiment of the present disclosure as viewed from the front upper left side, FIG. 14B is an external view showing the state of the power terminal as viewed from the left side, FIG. 14C is a sectional view taken along cut line f-f in FIG. 14B, which shows the state of the power terminal as viewed from the front side, and FIG. 14D is a sectional view taken along cut line g-g in FIG. 14B, which shows the state of the power terminal as viewed from above;

FIG. 15 is an external view showing the state of a signal terminal of the partner connector of the first embodiment of the present disclosure as viewed from the front upper left side;

FIG. 16 is a view for describing another method of connecting the connector and the partner connector according to the first embodiment of the present disclosure;

FIG. 17 is a view for describing a state of the connector and the partner connector being misaligned in the right-left direction in the first embodiment of the present disclosure;

FIGS. 18A to 18C are views for describing correction of the misalignment of the connector and the partner connector in the right-left direction when the connector and the partner connector are connected by being moved to each other in the up-down direction in the first embodiment of the present disclosure;

FIGS. 19A to 19D are views for describing correction of the misalignment of the connector and the partner connector in the right-left direction when the connector and the partner connector are connected by being moved to each other in the front-back direction in the first embodiment of the present disclosure;

FIG. 20 is an external view showing a connector device of a second embodiment of the present disclosure;

FIG. 21 is an external view showing a connector of the second embodiment of the present disclosure;

FIG. 22 is a sectional view taken along cut line m-m in FIG. 21, which shows the state of the connector as viewed from the left side;

FIG. 23 is an external view showing a partner connector of the second embodiment of the present disclosure; and

FIG. 24 is a sectional view taken along cut line n-n in FIG. 23, which shows the state of the partner connector as viewed from the left side.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The connector described in JP-A-2006-164682 has the following problems. Each terminal of the above-described connector is formed, for example, in such a manner that a thin band-shaped metal piece obtained by punching a metal plate member made of copper alloy or the like is bent, and for this reason, it is difficult to increase the current capacity of the terminal. Thus, in a case where the value of a current flowing between one board and the other board is great, it may be difficult to use the above-described connector as the connector for electrically connecting the boards. For example, in a case where the value of a power-supply current flowing from the battery-side board to the body-side board is great upon operation of the electric and electronic equipment, a case where the value of a charging current flowing from the body-side board to the battery-side board is great upon charging of the battery, or the like, it may be difficult to use the above-described connector as the connector for electrically connecting these boards.

Since each terminal of the above-described connector is formed by bending the thin band-shaped metal piece, the strength thereof is low. For this reason, there is a probability that when an external object contacts such a terminal, the terminal is abnormally plastically deformed and the shape of the terminal is changed from an original shape at the time of manufacturing. In a case where the terminal is abnormally plastically deformed, contact failure between the terminal of the connector and the terminal of the partner connector may be caused upon connection between the connector and the partner connector. As described above, the low strength of the terminal of the above-described connector leads to the low durability of the connector.

The present disclosure has been made in view of the above-described problems, and one of the objects of the present disclosure is to provide a connector capable of connecting boards to supply/receive power and transmit a signal between the boards, applying a power-supply current, a charging current, or the like having a great value from one board to the other board, and having a high durability and also provide a partner connector and a connector device.

A connector according to the present disclosure includes: two first terminals; a second terminal disposed between the two first terminals; and a terminal holder holding the first terminals and the second terminal, in which each first terminal has a first contact portion, the first contact portion protrudes in one direction from the terminal holder, and is formed so as not to elastically displace, the second terminal has a second contact portion, and the second contact portion protrudes in the one direction from the terminal holder, and is formed elastically displaceably in a direction opposite to the one direction.

In the connector according to the present disclosure, a protruding amount of the first contact portion from the terminal holder may be greater than a protruding amount of the second contact portion from the terminal holder.

Further, in the connector according to the present disclosure, a cross-sectional area of the first contact portion may be greater than a cross-sectional area of the second contact portion.

Moreover, in the connector according to the present disclosure, the second terminal may include a plurality of second terminals, and the plurality of second terminals may be arranged in line from one of the two first terminals to the other first terminal.

Further, in the connector according to the present disclosure, the first contact portion of each first terminal may be configured to contact a first partner terminal of a partner connector to be connected to the connector, and the second contact portion of the second terminal may be configured to elastically displace in the direction opposite to the one direction by contacting a second partner terminal of the partner connector.

In the connector of the present disclosure, the two first terminals are provided as power terminals and the second terminal is provided as a signal terminal, and therefore, the connector of the present disclosure can be used as the connector that connects the boards to supply/receive power and transmits a signal between the boards. In a case where the cross-sectional are of the second terminal formed elastically displaceably is great, there is a disadvantage that it is difficult to elastically displace the second terminal. However, in a case where the cross-sectional area of the first terminal formed so as not to elastically displace as in the connector of the present disclosure is great, there is no such a disadvantage. With the great cross-sectional area of the first terminal formed so as not to elastically displace, the current capacity of the first terminal can be increased. The first terminal is provided as the power terminal so that a power-supply current, a charging current, or the like having a great value can be applied from one board to the other board. In the connector of the present disclosure, each first terminal formed so as not to elastically displace has, for example, a great cross-sectional area, and therefore, the strength thereof can be enhanced. The protruding direction of the second terminal formed elastically displaceably is the same as the protruding direction of the two first terminals, and the second terminal is disposed between the two first terminals. The second terminal is disposed between the two first terminals formed so as not to elastically displace and having a high strength, so that the second terminal can be protected by the two first terminals. Thus, abnormal plastic deformation of the second terminal due to contact of an external object with the second terminal can be reduced, and the durability of the connector can be enhanced.

Further, a partner connector according to the present disclosure is a partner connector to be connected to a connector, the connector including two first terminals, a second terminal disposed between the two first terminals, and a terminal holder holding the first terminals and the second terminal, each first terminal protruding in one direction from the terminal holder and being formed so as not to elastically displace, and the second terminal protruding in the one direction from the terminal holder and being formed elastically displaceably in a direction opposite to the one direction. The partner connector includes: two first partner terminals; a second partner terminal; and a partner terminal holder holding the first partner terminals and the second partner terminal, in which the partner terminal holder has two recesses provided apart from each other, the first partner terminals are each disposed in the two recesses, each first partner terminal has a first partner contact portion configured to contact a corresponding one of the first terminals inserted into the recesses, the second partner terminal is disposed between the two recesses, and the second partner terminal has a second partner contact portion configured to contact the second terminal while pressing and elastically displacing the second terminal.

Further, in the partner connector according to the present disclosure, it may be configured such that each first partner terminal has a base portion extending in a front-back direction, the first partner contact portion has a pair of first contact pieces, a pair of extending portions, and a pair of second contact pieces, the pair of first contact pieces extends upward of right and left end portions of a back portion of the base portion, and contacts a corresponding one of the first terminals inserted into the recesses while sandwiching the corresponding one of the first terminals, the pair of extending portions extends upward of right and left end portions of a front portion of the base portion, the pair of second contact pieces extends backward of the pair of extending portions, and contacts a corresponding one of the first terminals inserted into the recesses while sandwiching the corresponding one of the first terminals, and the pair of first contact pieces is elastically displaceably formed such that upper end portions thereof are opened with lower end portions thereof as a base point, and the pair of second contact pieces is elastically displaceably formed such that back end portions thereof are opened with front end portions thereof as a base point.

Furthermore, in the partner connector according to the present disclosure, an upper end portion of each of the pair of first contact pieces may be provided with a first guide portion, the first guide portion may be configured to guide a corresponding one of the first terminals inserted into the recesses from thereabove to between the pair of first contact pieces, the front end portion of each of the pair of second contact pieces may be provided with a second guide portion, and the second guide portion may be configured to guide a corresponding one of the first terminals inserted into the recesses from a front thereof to between the pair of second contact pieces.

A connector device according to the present disclosure includes: a connector; and a partner connector to be connected to the connector. In the connector device, the connector includes two first terminals, a second terminal disposed between the two first terminals, and a terminal holder holding the first terminals and the second terminal, each first terminal has a first contact portion, the first contact portion protrudes in one direction from the terminal holder, is formed so as not to elastically displace, and is configured to contact a first partner terminal of the partner connector, the second terminal has a second contact portion, the second contact portion protrudes in the one direction from the terminal holder, is formed elastically displaceably in a direction opposite to the one direction, and by being pressed by a second partner terminal of the partner connector, contacts the second partner terminal while elastically displacing in the direction opposite to the one direction, the partner connector includes two first partner terminals as the first partner terminal, the second partner terminal, and a partner terminal holder holding the first partner terminals and the second partner terminal, the partner terminal holder has two recesses provided apart from each other, the first partner terminals are each disposed in the two recesses, each first partner terminal has a first partner contact portion configured to contact the first contact portion inserted into a corresponding one of the recesses, the second partner terminal is disposed between the two recesses, and the second partner terminal has a second partner contact portion configured to contact the second contact portion while pressing and elastically displacing the second contact portion.

According to the present disclosure, the boards can be connected to each other such that the power is supplied/received and the signal is transmitted between the boards, the power-supply current, the charging current, or the like having the great value can be applied from one board to the other board, and the durability of the connector can be enhanced.

In embodiments described below, an example where the connector, the partner connector, and the connector device according to the present disclosure are used as a connector, a partner connector, and a connector device for connecting body-side and battery-side boards of electric and electronic equipment to each other will be described.

### (First Embodiment)

### [Electric and Electronic Equipment]

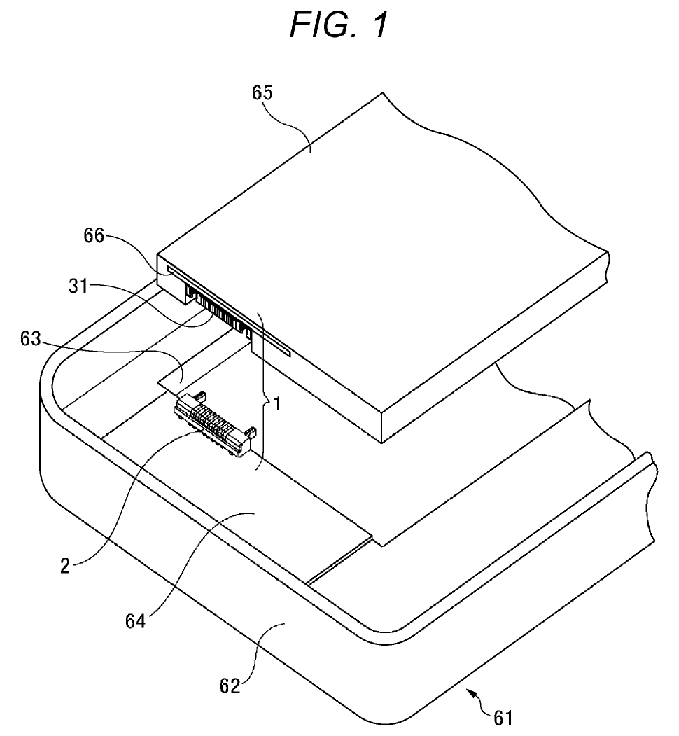

FIG. 1 shows electric and electronic equipment 61. The electric and electronic equipment 61 includes a body 62 and a battery 65. The battery 65 is detachable from the body 62. The body 62 is provided with a battery attachment recess 63 in which the battery 65 is fitted upon attachment of the battery 65 to the body 62. Further, the body 62 is provided with a body-side board 64. The battery 65 is provided with a battery-side board 66.

### [Connector Device]

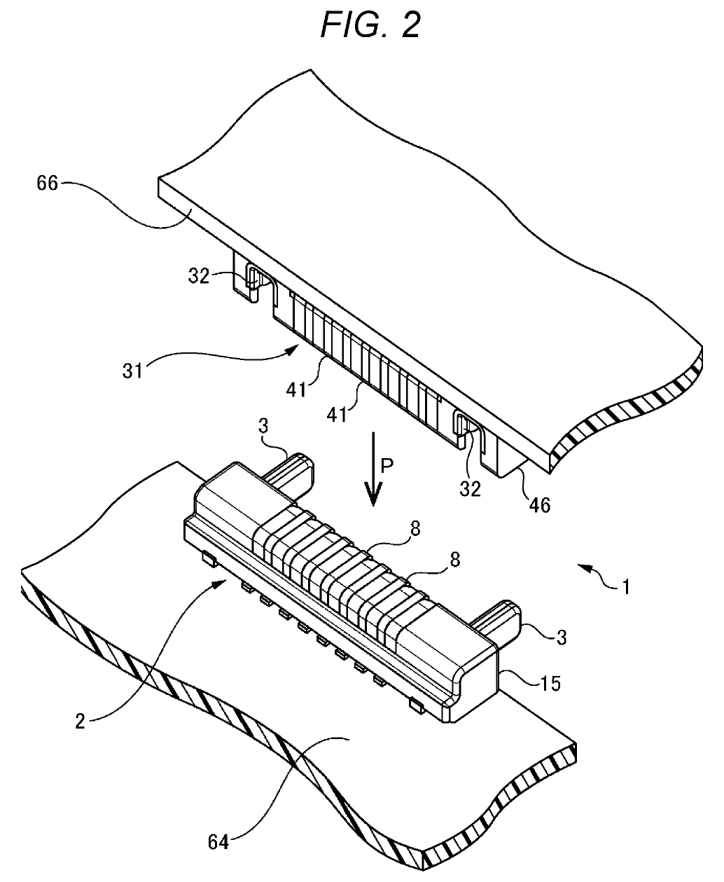

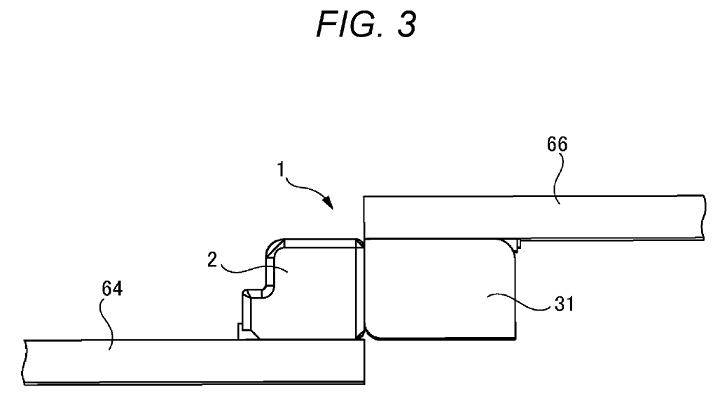

FIG. 2 shows only the body-side board 64, a connector 2, the battery-side board 66, and a partner connector 31 of FIG. 1. FIG. 3 shows a state of the connector 2 and the partner connector 31 being connected to each other. A connector device 1 of the present disclosure is provided in the electric and electronic equipment 61, and electrically connects the body-side board 64 and the battery-side board 66 to each other. As shown in FIG. 2, the connector device 1 includes the connector 2 of a first embodiment and the partner connector 31 of the first embodiment. The connector 2 and the partner connector 31 can be separatably connected to each other. The connector 2 is mounted on the body-side board 64, and the partner connector 31 is mounted on the battery-side board 66.

When the battery 65 is attached in the battery attachment recess 63 of the body 62, the connector 2 and the partner connector 31 are connected to each other as shown in FIG. 3. That is, the mounting position of the connector 2 on the body-side board 64 and the mounting position of the partner connector 31 on the battery-side board 66 are set such that the connector 2 and the partner connector 31 are connected as described above when the battery 65 is attached in the battery attachment recess 63 of the body 62.

### [Connector]

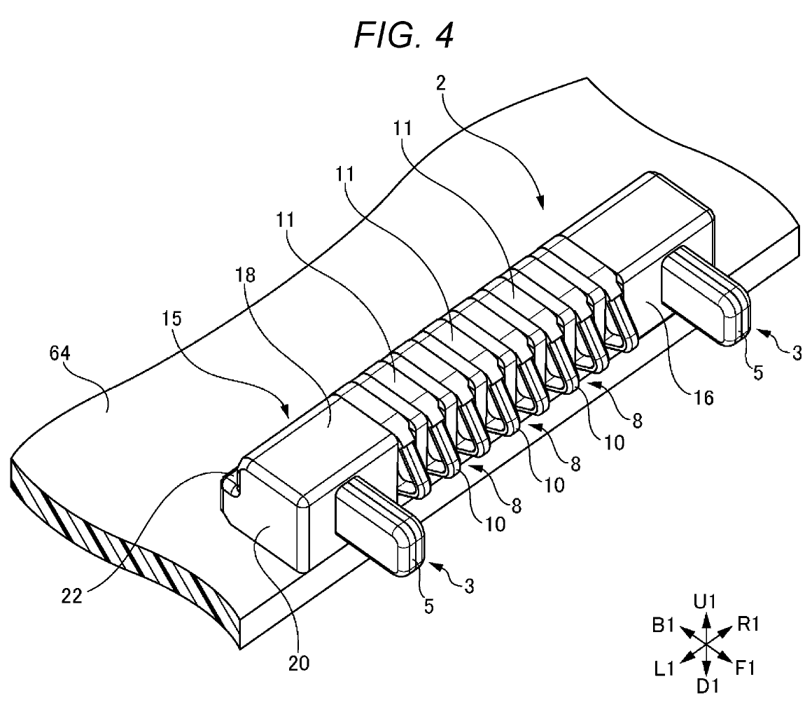

FIGS. 4 to 9C are views related to the connector 2. For the connector 2, the directions of up (U1), down (D1), front (F1), back (B1), left (L1), and right (R1) are indicated by arrows shown on the lower right side in FIGS. 4 to 9C for the sake of convenience in description.

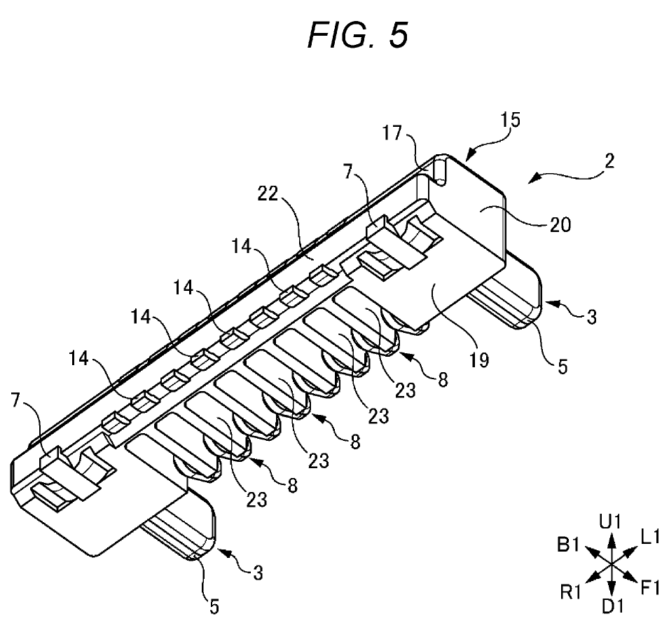

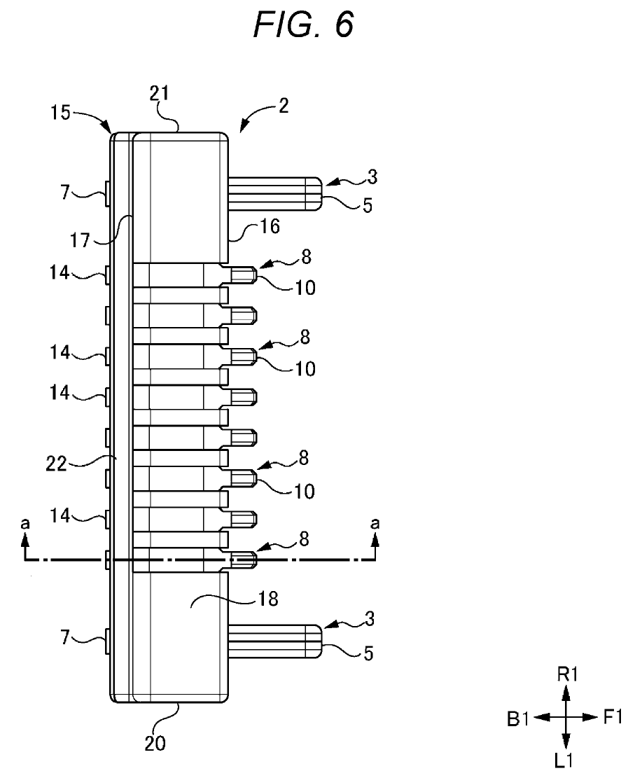

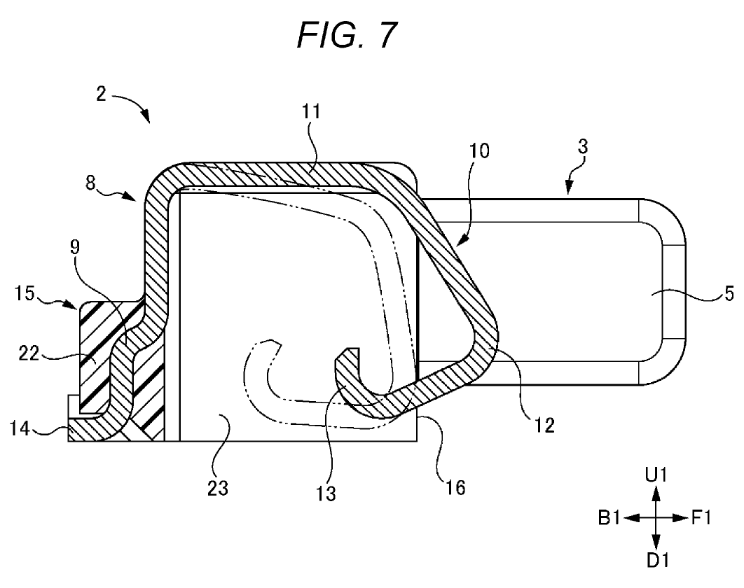

FIG. 4 shows the state of the connector 2 as viewed from the front upper left side. FIG. 5 shows the state of the connector 2 as viewed from the back lower left side. FIG. 6 shows the state of the connector 2 as viewed from above. FIG. 7 shows the state of the section of the connector 2 taken along cut line a-a in FIG. 6, as viewed from the left side (lower side in FIG. 6).

The connector 2 includes two power terminals 3, a plurality (for example, eight) of signal terminals 8, and a housing 15 holding the power terminals 3 and the signal terminals 8. Note that the power terminal 3 is a specific example of a “first terminal”, the signal terminal 8 is a specific example of a “second terminal”, and the housing 15 is a specific example of a “terminal holder”.

### [Housing of Connector]

The housing 15 of the connector 2 is made of an insulating material such as resin, for example. As shown in FIGS. 4 to 6, the housing 15 has a rectangular parallelepiped shape as a whole, and has a front surface 16, a back surface 17, an upper surface 18, a lower surface 19, a left surface 20, and a right surface 21.

The power terminal 3 is held at each of right and left portions of the housing 15.

A back portion of the housing 15 is provided with a signal terminal holding portion 22. The signal terminal holding portion 22 projects backward of a lower portion of the back surface of the housing 15 as shown in FIG. 7, and extends from a left end portion to a right end portion of the housing 15 as shown in FIG. 5. As shown in FIG. 7, a back portion of each signal terminal 8 is held at an intermediate portion of the signal terminal holding portion 22 in the front-back direction.

As shown in FIG. 5, a plurality of grooves 23 is formed in an intermediate portion of the housing 15 in the right-left direction. Each groove 23 extends backward from the front surface 16 of the housing 15 to a portion of the housing 15 up to a point immediately before the signal terminal holding portion 22, and extends from the upper surface 18 to the lower surface 19 of the housing 15. As a result, each groove 23 is continuously opened from an upper portion of the back surface 17 of the housing 15 to a back portion of the lower surface 19 through the upper surface 18 and the front surface 16. Moreover, the plurality of grooves 23 is arranged in line and in parallel at equal intervals in the right-left direction. The number of grooves 23 is the same as the number of signal terminals 8. As shown in FIG. 7, in each groove 23, a front portion of the signal terminal 8 with respect to a portion of the signal terminal 8 held by the signal terminal holding portion 22 is displaceably located.

The housing 15 is formed by insert molding. The housing 15 is integrated with a back portion of each power terminal 3 and a back portion of each signal terminal 8 by insert molding.

### [Power Terminal of Connector]

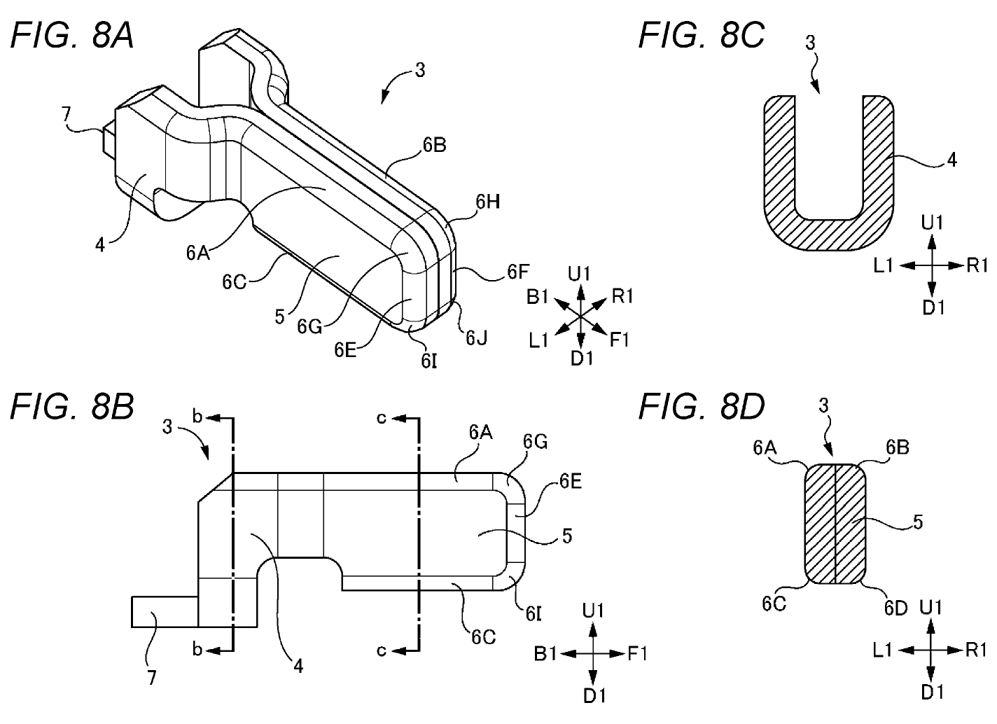

FIG. 8A shows the state of the power terminal 3 of the connector 2 as viewed from the front upper left side. FIG. 8B shows the state of the power terminal 3 as viewed from the left side. FIG. 8C shows the state of the section of the power terminal 3 taken along cut line b-b in FIG. 8B, as viewed from the front side (right side in FIG. 8B). FIG. 8D shows the state of the section of the power terminal 3 taken along cut line c-c in FIG. 8B, as viewed from the front side (right side in FIG. 8B).

The two power terminals 3 of the connector 2 have the same configuration. Each power terminal 3 is made of a metal material such as copper alloy, for example. As shown in FIG. 8A, each power terminal 3 is formed in a rod shape, a column shape, or a blade shape extending in the front-back direction. Each power terminal 3 is formed in such a manner that a metal piece obtained by punching a metal plate member into a predetermined flat plate shape is bent.

A back portion of each power terminal 3 is formed with a fixing portion 4 for fixing the power terminal 3 to the housing 15. As shown in FIG. 8C, the cross-sectional shape of the fixing portion 4 is a U-shape.

A front portion of each power terminal 3 is formed with a contact portion 5 contacting a power terminal 32 of the partner connector 31 upon connection between the connector 2 and the partner connector 31. The contact portion 5 of each power terminal 3 is formed so as not to elastically displace. As shown in FIG. 8D, the cross-sectional shape of the contact portion 5 is a rectangular. Note that the contact portion 5 is a specific example of a “first contact portion”.

An upper left corner portion of the contact portion 5 is formed with a chamfered portion 6A by chamfering such a corner portion. Moreover, an upper right corner portion, a lower left corner portion, a lower right corner portion, a front left corner portion, a front right corner portion, a front upper left corner portion, a front upper right corner portion, a front lower left corner portion, and a front lower right corner portion of the contact portion 5 are also formed with chamfered portions 6B to 6J.

A back end portion of each power terminal 3 is formed with a board connection portion 7 to be connected to a circuit of the body-side board 64. The board connection portion 7 extends backward of a lower portion of a back end portion of the fixing portion 4.

As shown in FIGS. 4 to 6, the fixing portion 4 of one of the two power terminals 3 is embedded in a left portion of the housing 15, and is fixed to the left portion of the housing 15. The contact portion 5 of the one power terminal 3 protrudes forward of the front surface 16 of the housing 15 from the left portion thereof. The board connection portion 7 of the one power terminal 3 is positioned at a back lower portion of the left portion of the housing 15, and is exposed to the outside from the housing 15. Moreover, the board connection portion 7 of the one power terminal 3 is located such that the lower surface thereof is flush with the lower surface 19 of the housing 15. The fixing portion 4 of the other power terminal 3 is embedded in a right portion of the housing 15, and is fixed to the right portion of the housing 15. The contact portion 5 of the other power terminal 3 protrudes forward of the front surface 16 of the housing 15 from the right portion thereof. The board connection portion 7 of the other power terminal 3 is positioned at a back lower portion of the right portion of the housing 15, and is exposed to the outside from the housing 15. Moreover, the board connection portion 7 of the other power terminal 3 is located such that the lower surface thereof is flush with the lower surface 19 of the housing 15. The two power terminals 3 extend in parallel in the front-back direction, and are the same as each other in a direction of the contact portion 5 protruding from the housing 15.

### [Signal Terminal of Connector]

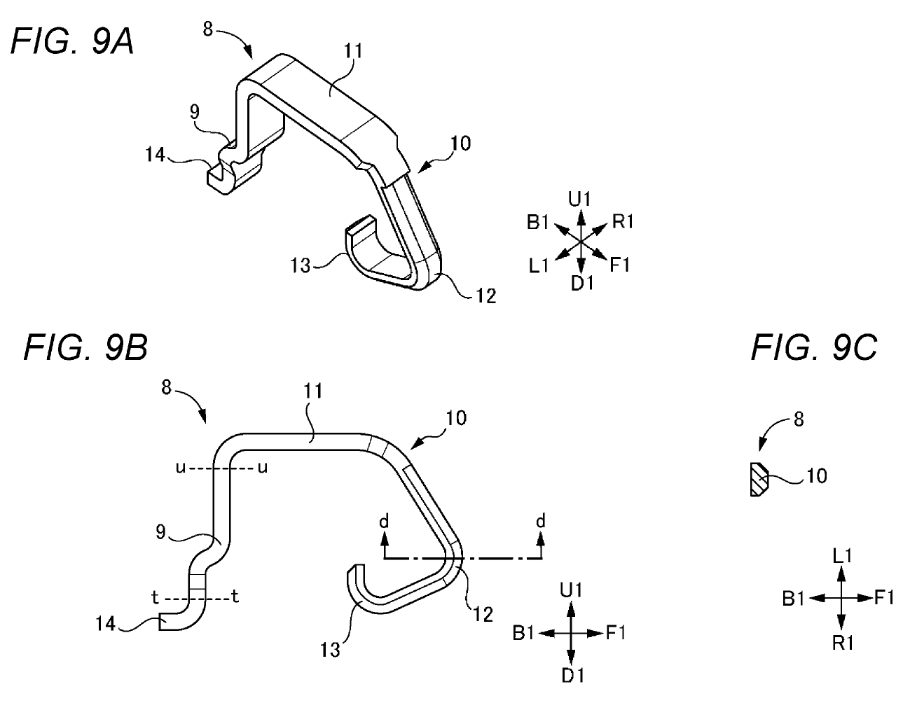

FIG. 9A shows the state of the signal terminal 8 of the connector 2 as viewed from the front upper left side. FIG. 9B shows the state of the signal terminal 8 as viewed from the left side. FIG. 9C shows the state of the section of the signal terminal 8 taken along cut line d-d in FIG. 9B, as viewed from below.

The plurality of signal terminals 8 of the connector 2 has the same configuration. Each signal terminal 8 is made of a metal material such as copper alloy, for example. Each signal terminal 8 is a compression terminal or a spring terminal. Each signal terminal 8 is formed in such a manner that a thin band-shaped metal piece obtained by punching a metal plate member is bent as shown in FIG. 9A.

A back portion of each signal terminal 8 is formed with a fixing portion 9 for fixing the signal terminal 8 itself to the housing 15. Of the back portion of each signal terminal 8, a portion extending in the up-down direction as a whole between a dashed line t-t and a dashed line u-u is the fixing portion 9, as shown in FIG. 9B.

A front portion of each signal terminal 8 is formed with a contact portion 10 contacting a signal terminal 41 of the partner connector 31 upon connection between the connector 2 and the partner connector 31. The contact portion 10 is elastically displaceably formed. The contact portion 10 has a spring portion 11, a contact point portion 12, and a curved portion 13. The spring portion 11 is curved diagonally to the front lower side after having extended forward of an upper end portion of the fixing portion 9, and then extends diagonally to the front lower side. The contact point portion 12 is located at a lower end portion of a portion of the spring portion 11 extending diagonally to the front lower side. That is, the frontmost portion of the contact portion 10 is the contact point portion 12. The curved portion 13 is curved upward after having extended diagonally to the back lower side from the contact point portion 12, and then extends upward. Note that the contact portion 10 is a specific example of a “second contact portion”.

A back end portion of each signal terminal 8 is formed with a board connection portion 14 to be connected to the circuit of the body-side board 64. The board connection portion 14 extends backward of a lower end portion of the fixing portion 9.

In FIG. 7, a lower portion of the fixing portion 9 of each signal terminal 8 is embedded in the signal terminal holding portion 22 of the housing 15, and is fixed to the signal terminal holding portion 22.

The contact portion 10 of each signal terminal 8 is displaceably located in the groove 23 of the housing 15. That is, the contact portion 10 is movable in the groove 23 of the housing 15. In a state of the connector 2 and the partner connector 31 being not connected to each other, the contact portion 10 is not elastically displaced. In a state of the contact portion 10 being not elastically displaced, a back portion of the spring portion 11 extends forward along the upper surface 18 of the housing 15 (the upper surface of the back portion of the spring portion 11 is flush with the upper surface 18 of the housing 15), and a front portion of the spring portion 11 and the contact point portion 12 protrude from the groove 23. That is, the front portion of the spring portion 11 protrudes forward of the front surface 16 of the housing 15, and the contact point portion 12 is positioned forward of the front surface 16 of the housing 15.

When the connector 2 and the partner connector 31 are connected to each other, a portion of the contact portion 10 protruding forward of the groove 23 of the housing 15 is pressed backward (in the direction of an arrow B1 in FIG. 7) by the signal terminal 41 of the partner connector 31. Accordingly, the contact portion 10 is elastically displaced. Specifically, the spring portion 11 of the contact portion 10 is elastically deformed backward as indicated by a dash-dot-dot line in FIG. 7, a large portion of the contact portion 10 enters the groove 23, and the contact point portion 12 of the contact portion 10 is displaced backward.

A back end portion of the curved portion 13 of the contact portion 10 is constantly positioned in the groove 23 not only when the contact portion 10 is not elastically displaced but also when the contact portion 10 is elastically displaced. Since the back end portion (i.e., a free-end-side tip end portion of the contact portion 10) of the curved portion 13 of the contact portion 10 is constantly positioned in the groove 23, a probability of the shape of the contact portion 10 being deformed from an original shape at the time of manufacturing due to abnormal plastic deformation of the contact portion 10 caused by a thread-shaped or string-shaped object being hooked on the free-end-side portion of the contact portion 10 can be reduced.

The board connection portion 14 of each signal terminal 8 is exposed to the outside of the housing 15 from a lower portion of the signal terminal holding portion 22 of the housing 15. Each board connection portion 14 is located such that the lower surface thereof is flush with the lower surface 19 of the housing 15.

As shown in FIGS. 4 to 6, the plurality of signal terminals 8 is arranged in parallel. Moreover, the plurality of signal terminals 8 is arranged in line at equal intervals in the right-left direction from one power terminal 3 to the other power terminal 3. In a state of the contact portion 10 of each signal terminal 8 being not elastically displaced, the plurality of signal terminals 8 is the same as each other in a direction of the contact portion 10 protruding from the housing 15, and the direction of the contact portion 10 protruding from the housing 15 is the same as the direction of the contact portion 5 of each power terminal 3 protruding from the housing 15.

### [Cross-Sectional Area of Each Terminal of Connector]

As can be seen from comparison between FIGS. 8D and 9C, in the connector 2, the cross-sectional area of the contact portion 5 of each power terminal 3 is greater than the cross-sectional area of the contact portion 10 of each signal terminal 8. For the power terminal 3, a thick metal plate member is used, the punched shape is set, and the bending method is set such that the cross-sectional area of the power terminal 3 is greater than the cross-sectional area of the signal terminal 8. That is, any of the power terminal 3 and the signal terminal 8 is manufactured in such a manner that the metal piece obtained by punching the metal plate member is bent, but the thickness of the metal plate member used for manufacturing the power terminal 3 is greater than the thickness of the metal plate member used for manufacturing the signal terminal 8. Moreover, the signal terminal 8 is formed by punching the metal plate member into the thin band shape, whereas the power terminal 3 is formed by punching the metal plate member into the predetermined flat plate shape. Further, the contact portion 10 of the signal terminal 8 is formed in such a manner that the thin band-shaped metal piece obtained by punching the metal plate member is bent such that part of the metal piece does not overlap with another part of the metal piece. On the other hand, the contact portion 5 of the power terminal 3 is formed in such a manner that the metal piece obtained by punching the metal plate member into the predetermined flat plate shape is bent such that two portions of the metal piece overlap with each other.

As a result of comparison between the power terminal 3 and the signal terminal 8, not only the cross-sectional area of the contact portion 5, 10 but also the cross-sectional area of each portion other than the contact portion 5, 10 is greater in the power terminal 3 than the signal terminal 8. Thus, the current capacity of the power terminal 3 is greater than the current capacity of the signal terminal 8. Thus, upon operation of the electric and electronic equipment 61, a power-supply current having a greater value than that of a signal current can be applied from the battery-side board 66 to the body-side board 64 through each power terminal 3. Moreover, upon charging of the battery 65, a charging current having a greater value than that of the signal current can be applied from the body-side board 64 to the battery-side board 66 through each power terminal 3.

### [Strength and Arrangement of Each Terminal of Connector]

In the connector 2, each power terminal 3 is formed so as not to elastically displace, and has a greater cross-sectional area than that of the signal terminal 8. Thus, each power terminal 3 has a higher strength than that of the signal terminal 8. As shown in FIG. 6, each signal terminal 8 is disposed between the two power terminals 3. Moreover, any of the signal terminals 8 and the power terminals 3 protrudes forward of the front surface 16 of the housing 15, and the signal terminals 8 and the power terminals 3 are the same as each other in the protruding direction. As described above, in the connector 2, each signal terminal 8 is disposed between the two power terminals 3 having the high strength. With this configuration, each signal terminal 8 can be protected by the two power terminals 3, and therefore, the durability of the connector 2 can be enhanced.

That is, the signal terminal 8 is elastically displaceably formed by bending the thin band-shaped metal piece, and for this reason, there is a probability that when an external object contacts the signal terminal 8, the signal terminal 8 is abnormally plastically deformed and the shape of the signal terminal 8 is changed from the original shape at the time of manufacturing. However, each signal terminal 8 is disposed between the two power terminals 3 having the high strength, and therefore, the contact of the external object having approached the connector 2 with the signal terminal 8 can be reduced by the power terminal 3.

Specifically, when a user attaches the battery 65 to the body 62 in FIG. 1, the user holds the battery 65 with one’s hand, and fits the battery 65 into the battery attachment recess 63 of the body 62. At this time, the user first holds the battery 65 with one’s hand, and sets the position of the battery 65 such that when the body 62 is viewed from above in FIG. 1, the battery 65 precisely overlaps with the battery attachment recess 63 and the lower surface of the battery 65 is parallel with the bottom surface of the battery attachment recess 63. Thereafter, the user moves the battery 65 vertically downward in FIG. 1 and fits the battery 65 into the battery attachment recess 63 while maintaining the state of the lower surface of the battery 65 being parallel with the bottom surface of the battery attachment recess 63. When the battery 65 is fitted into the battery attachment recess 63 in this manner, the connector 2 is correctly connected to the partner connector 31.

However, in some cases, contrary to this correct method of attaching the battery 65 to the body 62, the user may attempt to fit the battery 65 into the battery attachment recess 63 in a state of the battery 65 being greatly misaligned from the battery attachment recess 63 when the body 62 is viewed from above or to fit the battery 65 into the battery attachment recess 63 in a state of the lower surface of the battery 65 being greatly inclined with respect to the bottom surface of the battery attachment recess 63. In this case, if each signal terminal 8 is not disposed between the two power terminals 3 and there is no object protruding forward of the front surface 16 of the housing 15 on both the right and left sides of the arrangement of the signal terminals 8, a portion of the battery 65 other than a portion where the partner connector 31 is provided contacts the signal terminal 8, which may abnormally plastically deform the signal terminal 8.

In the connector 2 of the present embodiment, each signal terminal 8 is disposed between the two power terminals 3, and the power terminals 3 protruding forward of the front surface 16 of the housing 15 are present on both the right and left sides of the arrangement of the signal terminals 8. Thus, when the user attempts to attach the battery 65 to the body 62 contrary to the correct method of attaching the battery 65 to the body 62 as described above, the portion of the battery 65 other than the portion where the partner connector 31 is provided contacts the power terminal 3. This avoids the portion of the battery 65 other than the portion where the partner connector 31 is provided from contacting the signal terminal 8. Thus, the abnormal plastic deformation of the signal terminal 8 can be reduced.

The plurality of signal terminals 8 is arranged in line from one power terminal 3 to the other power terminal 3. With this configuration, all the plurality of signal terminals 8 can be disposed between the two power terminals 3, and therefore, the two power terminals 3 can protect all the plurality of signal terminals 8.

### [Protruding Amount of Each Terminal of Connector]

As can be seen from FIG. 6, in the connector 2, the protruding amount of the contact portion 5 of each power terminal 3 from the housing 15 is greater than the protruding amount of each signal terminal 8 from the housing 15. In the present embodiment, the protruding amount of the contact portion 5 of each power terminal 3 from the housing 15 is equal to or greater than twice the protruding amount of each signal terminal 8 from the housing 15. Thus, the external object is less likely to contact the signal terminal 8. Consequently, an effect of reducing the contact of the external object with the signal terminal 8 by the two power terminals 3 can be enhanced, and the durability of the connector 2 can be further enhanced.

### [Partner Connector]

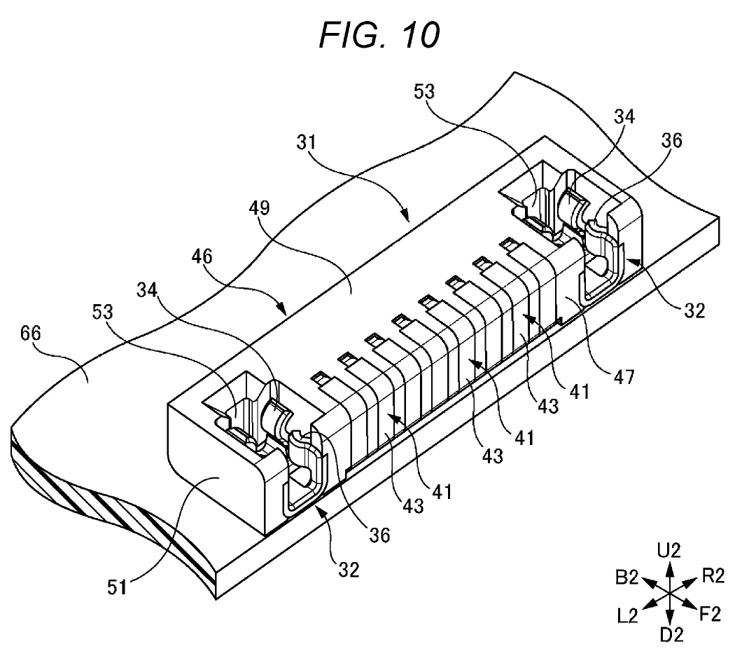

FIGS. 10 to 15 are views related to the partner connector 31. For the partner connector 31, the directions of up (U2), down (D2), front (F2), back (B2), left (L2), and right (R2) are indicated by arrows shown on the lower right side in FIGS. 10 to 15 for the sake of convenience in description.

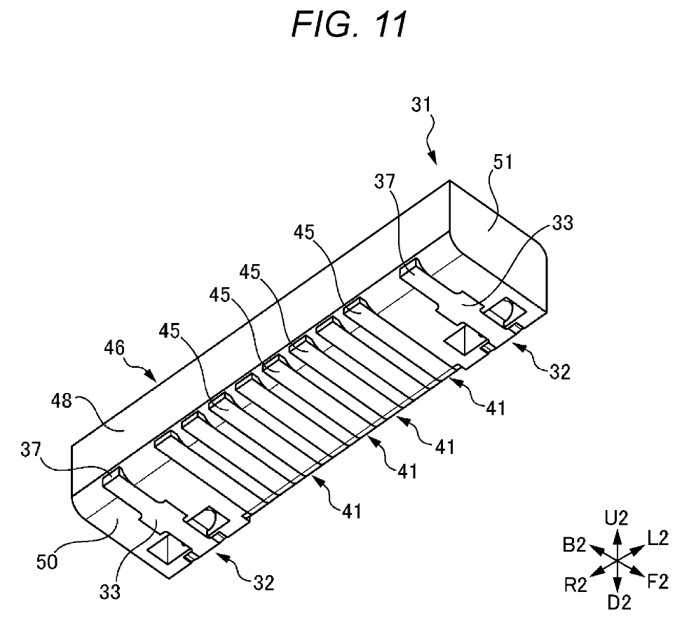

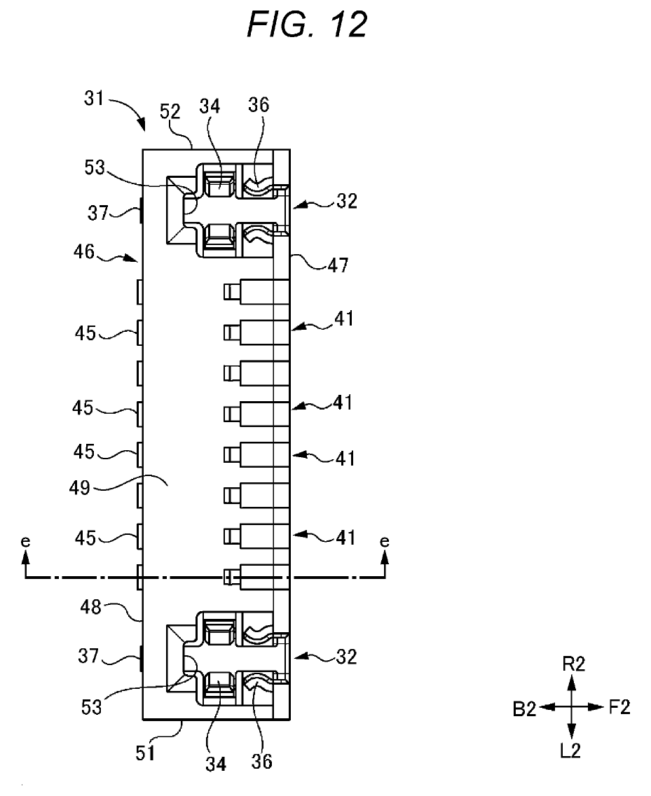

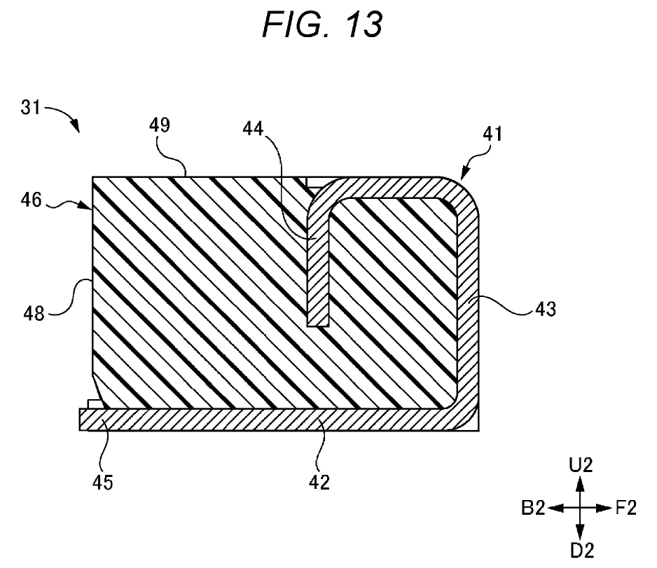

FIG. 10 shows the state of the partner connector 31 as viewed from the front upper left side. FIG. 11 shows the state of the partner connector 31 as viewed from the back lower left side. FIG. 12 shows the state of the partner connector 31 as viewed from above. FIG. 13 shows the state of the section of the partner connector 31 taken along cut line e-e in FIG. 12, as viewed from the left side (lower side in FIG. 12).

The partner connector 31 includes two power terminals 32, a plurality (for example, eight) of signal terminals 41, and a housing 46 holding the power terminals 32 and the signal terminals 41. Note that the power terminal 32 is a specific example of a “first partner terminal”, the signal terminal 41 is a specific example of a “second partner terminal”, and the housing 46 is a specific example of a “partner terminal holder”.

### [Housing of Partner Connector]

The housing 46 of the partner connector 31 is made of an insulating material such as resin, for example. As shown in FIGS. 10 to 12, the housing 46 has a rectangular parallelepiped shape as a whole, and has a front surface 47, a back surface 48, an upper surface 49, a lower surface 50, a left surface 51, and a right surface 52.

The housing 46 is provided with two recesses 53 at two positions apart from each other. One of the two recesses 53 provided apart from each other is located in a left portion of the housing 46, and the other recess 53 is located in a right portion of the housing 46. Each recess 53 is opened continuously to the front surface 47 and the upper surface 49 of the housing 46. One of the two power terminals 32 is held in the left recess 53, and the other power terminal 32 is held in the right recess 53. The plurality of signal terminals 41 is held at an intermediate portion of the housing 46 in the right-left direction. The housing 46 is formed by insert molding. The housing 46 is integrated with base portions 33 of the power terminals 32 and the signal terminals 41 by insert molding.

### [Power Terminal of Partner Connector]

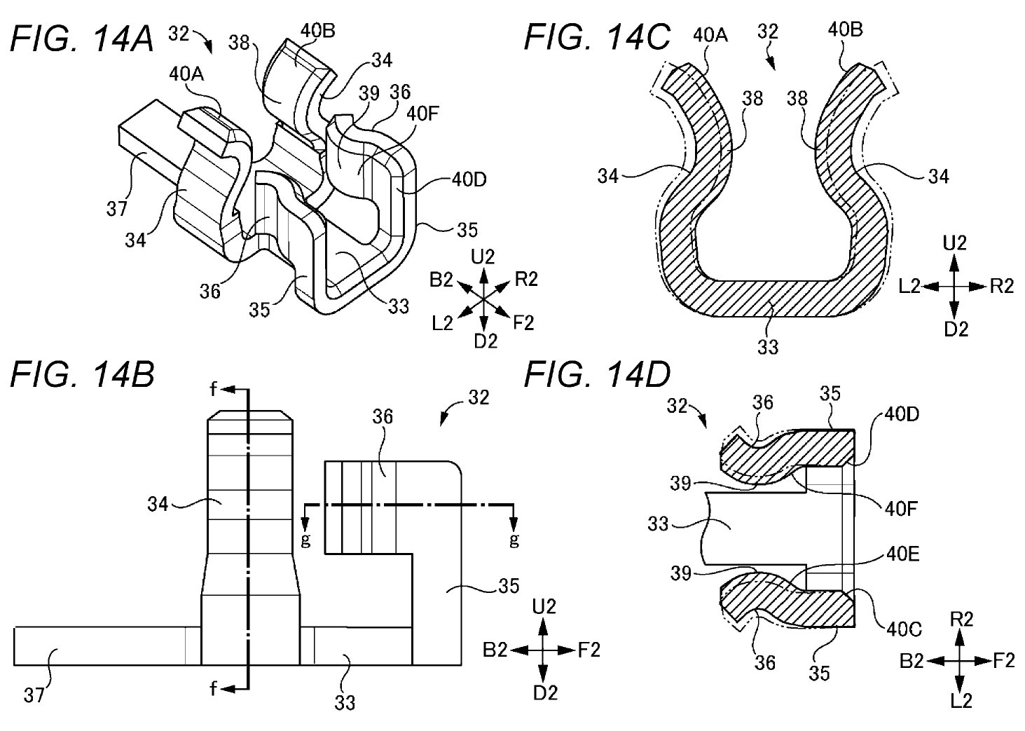

FIG. 14A shows the state of the power terminal 32 of the partner connector 31 as viewed from the front upper left side. FIG. 14B shows the state of the power terminal 32 as viewed from the left side. FIG. 14C shows the state of the section of the power terminal 32 taken along cut line f-f in FIG. 14B, as viewed from the front side (right side in FIG. 14B). FIG. 14D shows the state of the section of the power terminal 32 taken along cut line g-g in FIG. 14B, as viewed from above.

The two power terminals 32 of the partner connector 31 have the same configuration. Each power terminal 32 is made of a metal material such as copper alloy, for example. Each power terminal 32 is formed in such a manner that a metal piece obtained by punching a metal plate member into a predetermined flat plate shape is bent.

As shown in FIGS. 14A and 14B, each power terminal 32 has the base portion 33, a pair of first contact pieces 34, a pair of extending portions 35, a pair of second contact pieces 36, and a board connection portion 37. Note that a portion of the power terminal 32 formed of the pair of first contact pieces 34, the pair of extending portions 35, and the pair of second contact pieces 36 is a specific example of a “first partner contact portion”.

The base portion 33 extends in the front-back direction. The pair of first contact pieces 34 extends upward of right and left end portions of a back portion of the base portion 33. The pair of extending portions 35 extends upward of right and left end portions of a front portion of the base portion 33. The pair of second contact pieces 36 extends backward of upper portions of the pair of extending portions 35. The board connection portion 37 is formed at a back end portion of the base portion 33.

As shown in FIG. 14C, the pair of first contact pieces 34 is curved inward such that intermediate portions thereof in the up-down direction are closer to each other than upper end portions and lower end portions thereof. Each of the intermediate portions of the pair of first contact pieces 34 in the up-down direction is provided with a contact point portion 38. The upper end portion of a left one of the pair of first contact pieces 34 is formed with a guide portion 40A, and the upper end portion of the right first contact piece 34 is formed with a guide portion 40B. That is, the upper end portions of the pair of first contact pieces 34 are opened upward. Of the inner surfaces of these opened upper end portions of the pair of first contact pieces 34, the inner surface of the upper end portion of the left first contact piece 34 is the guide portion 40A, and the inner surface of the upper end portion of the right first contact piece 34 is the guide portion 40B. Each of the guide portions 40A, 40B has a function of guiding the contact portion 5 of the power terminal 3 of the connector 2 inserted into the recess 53 from thereabove to between the pair of first contact pieces 34. Note that the guide portion 40A, 40B is a specific example of a “first guide portion”.

A front right corner portion of the left extending portion 35 is formed with a guide portion 40C connecting the right surface and the front end surface of the extending portion 35 through a gently-curved or inclined surface. A front left corner portion of the right extending portion 35 is formed with a guide portion 40D connecting the left surface and the front end surface of the extending portion 35 through a gently-curved or inclined surface. Each of the guide portions 40C, 40D has a function of guiding the contact portion 5 of the power terminal 3 of the connector 2 inserted into the recess 53 from the front thereof to between the pair of extending portions 35.

As shown in FIG. 14D, the pair of second contact pieces 36 is curved inward such that intermediate portions thereof in the front-back direction are closer to each other than front end portions and back end portions thereof. Each of the intermediate portions of the pair of second contact pieces 36 in the front-back direction is provided with a contact point portion 39. The front end portion of a left one of the pair of second contact pieces 36 is formed with a guide portion 40E. That is, of the inner surface of the front end portion of the left second contact piece 36, the surface inclined rightward (inward) toward the back side is the guide portion 40E. Moreover, the front end portion of the right second contact piece 36 is formed with a guide portion 40F. That is, of the inner surface of the front end portion of the right second contact piece 36, the surface inclined leftward (inward) toward the back side is the guide portion 40F. Each of the guide portions 40E, 40F has a function of guiding the contact portion 5 of the power terminal 3 of the connector 2 inserted into the recess 53 from the front thereof to between the pair of second contact pieces 36. Note that the guide portion 40E, 40F is a specific example of a “second guide portion”.

Upon connection between the connector 2 and the partner connector 31, the contact point portions 38 of the pair of first contact pieces 34 and the contact point portions 39 of the pair of second contact pieces 36 sandwich the contact portion 5 of the power terminal 3 of the connector 2 inserted into the recess 53 of the housing 46 while contacting the contact portion 5.

Each first contact piece 34 is elastically displaceably formed. That is, upon connection between the connector 2 and the partner connector 31, the contact portion 5 of the power terminal 3 of the connector 2 enters between the pair of first contact pieces 34 and between the pair of second contact pieces 36. When the contact portion 5 of the power terminal 3 of the connector 2 enters between the pair of first contact pieces 34, each first contact piece 34 is pressed by the contact portion 5 of the power terminal 3 of the connector 2, and is elastically deformed. Then, the pair of first contact pieces 34 is displaced such that the upper end portions thereof are opened with the lower end portions thereof as a base point, as indicated by a dash-dot-dot line in FIG. 14C. Accordingly, the contact point portions 38 of the pair of first contact pieces 34 strongly contact the right and left surfaces of the contact portion 5 of the power terminal 3 of the connector 2 while pressing the right and left surfaces of the contact portion 5.

Each second contact piece 36 is elastically displaceably formed. That is, when the contact portion 5 of the power terminal 3 of the connector 2 enters between the pair of second contact pieces 36, each second contact piece 36 is pressed by the contact portion 5 of the power terminal 3 of the connector 2, and is elastically deformed. Then, the pair of second contact pieces 36 is displaced such that the back end portions thereof are opened with the front end portions thereof as a base point, as indicated by a dash-dot-dot line in FIG. 14D. Accordingly, the contact point portions 39 of the pair of second contact pieces 36 strongly contact the right and left surfaces of the contact portion 5 of the power terminal 3 of the connector 2 while pressing the right and left surfaces of the contact portion 5.

As shown in FIG. 10, each first contact piece 34, each extending portion 35, and each second contact piece 36 of one of the two power terminals 32 are disposed in the left recess 53 of the housing 46. As shown in FIG. 11, the base portion 33 of the one power terminal 32 is located such that the lower surface thereof is flush with the lower surface 50 of the housing 46. A large portion of the base portion 33 other than the lower surface thereof is embedded in a lower left portion of the housing 46, and is fixed to the lower left portion of the housing 46. The board connection portion 37 of the one power terminal 32 is positioned at a back portion of the lower left portion of the housing 46, and is exposed to the outside from the housing 46. Such a board connection portion 37 is located such that the lower surface thereof is flush with the lower surface 50 of the housing 46.

As shown in FIG. 10, each first contact piece 34, each extending portion 35, and each second contact piece 36 of the other power terminal 32 are disposed in the right recess 53 of the housing 46. As shown in FIG. 11, the base portion 33 of the other power terminal 32 is located such that the lower surface thereof is flush with the lower surface 50 of the housing 46. A large portion of the base portion 33 other than the lower surface thereof is embedded in a lower right portion of the housing 46, and is fixed to the lower right portion of the housing 46. The board connection portion 37 of the other power terminal 32 is positioned at a back portion of the lower right portion of the housing 46, and is exposed to the outside from the housing 46. Such a board connection portion 37 is located such that the lower surface thereof is flush with the lower surface 50 of the housing 46.

The arrangement of the two power terminals 32 of the partner connector 31 is set corresponding to the arrangement of the two power terminals 3 of the connector 2.

### [Signal Terminal of Partner Connector]

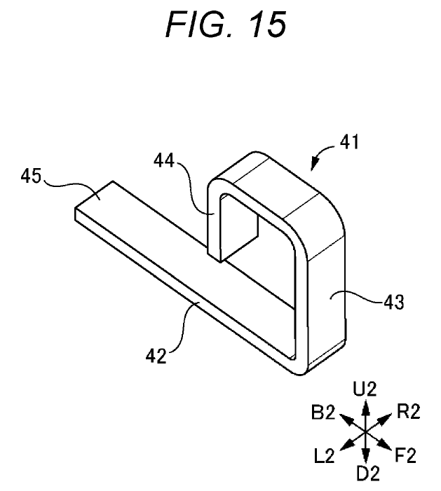

FIG. 15 shows the state of the signal terminal 41 of the partner connector 31 as viewed from the front upper left side. The plurality of signal terminals 41 of the partner connector 31 has the same configuration. Each signal terminal 41 is made of a metal material such as copper alloy, for example. Each signal terminal 41 is formed in such a manner that a thin band-shaped metal piece obtained by punching a metal plate member is bent as shown in FIG. 15.

Each signal terminal 41 has a base portion 42 extending in the front-back direction, a contact portion 43 extending upward of a front end portion of the base portion 42, a bent portion 44 bent downward after having extended backward of an upper end portion of the contact portion 43 and then extending downward, and a board connection portion 45 located at a back end portion of the base portion 42. The contact portion 43 has a flat front surface.

Upon connection between the connector 2 and the partner connector 31, the contact portion 43 of the signal terminal 41 of the partner connector 31 contacts the contact portion 10 of the signal terminal 8 of the connector 2 while pressing the contact portion 10 to elastically displace the contact portion 10. Note that the contact portion 43 is a specific example of a “second partner contact portion”.

In other words, upon connection between the connector 2 and the partner connector 31, the contact portion 10 of the signal terminal 8 of the connector 2 is elastically deformed by contacting the contact portion 43 of the signal terminal 41 of the partner connector 31. That is, the contact portion 10 of the connector 2 contacts the contact portion 43 of the partner connector 31 while being elastically deformed by being pressed by the contact portion 43 of the partner connector 31. The elastic displacement direction of the contact portion 10 at this time is a direction (backward) opposite to the protruding direction (forward) of the contact portion 10.

As shown in FIGS. 10 to 13, in each signal terminal 41, the lower surface of the base portion 42, the front surface of the contact portion 43, and the upper surface of a front portion of the bent portion 44 are exposed to the outside from the housing 46. In each signal terminal 41, the base portion 42 is located at a lower portion of the housing 46 such that the lower surface thereof is flush with the lower surface 50 of the housing 46. The contact portion 43 is located at a front portion of the housing 46 such that the front surface thereof is flush with the front surface 47 of the housing 46. The front portion of the bent portion 44 is located such that the upper surface thereof is flush with the upper surface 49 of the housing 46. A portion of each signal terminal 41 other than the lower surface of the base portion 42, the front surface of the contact portion 43, the upper surface of the front portion of the bent portion 44, and the board connection portion 45 is embedded in the housing 46, and is fixed to the housing 46. A back portion of the bent portion 44, i.e., a downwardly-extending portion of the bent portion 44, is embedded in the housing 46, and therefore, the signal terminal 41 is strongly fixed to the housing 46. The board connection portion 45 of each signal terminal 41 is positioned at a back lower portion of the housing 46, and is exposed to the outside from the housing 46. The board connection portion 45 is located such that the lower surface thereof is flush with the lower surface 50 of the housing 46.

The plurality of signal terminals 41 is disposed between the two recesses 53 formed in the housing 46. The plurality of signal terminals 41 is arranged in parallel. The plurality of signal terminals 41 is arranged in line at equal intervals in the right-left direction from one recess 53 to the other recess 53. The arrangement of the plurality of signal terminals 41 of the partner connector 31 is set corresponding to the arrangement of the plurality of signal terminals 8 of the connector 2.

### [Cross-Sectional Area of Each Terminal of Partner Connector]

Any of the power terminals 32 and the signal terminals 41 of the partner connector 31 is manufactured in such a manner that the metal piece obtained by punching the metal plate member is bent, but the thickness of the metal plate member used for manufacturing the power terminal 32 is greater than the thickness of the metal plate member used for manufacturing the signal terminal 41. Thus, the cross-sectional area of each portion of the power terminal 32 is greater than the cross-sectional area of each portion of the signal terminal 41. Consequently, the current capacity of the power terminal 32 is greater than the current capacity of the signal terminal 41. As a result, upon operation of the electric and electronic equipment 61, a power-supply current having a greater value than that of the signal current can be applied from the battery-side board 66 to the body-side board 64 through each power terminal 32. Upon charging of the battery 65, a charging current having a greater value than that of the signal current can be applied from the body-side board 64 to the battery-side board 66 through each power terminal 32.

### [Mounting of Each Connector on Board]

As shown in FIG. 4, the board connection portion 7 of each power terminal 3 and the board connection portion 14 of each signal terminal 8 are soldered to a plurality of pads formed on the upper surface of the body-side board 64, and in this manner, the connector 2 is surface-mounted on the upper surface of the body-side board 64. As shown in FIG. 10, the board connection portion 37 of each power terminal 32 and the board connection portion 45 of each signal terminal 41 are soldered to a plurality of pads formed on the upper surface of the battery-side board 66, and in this manner, the partner connector 31 is surface-mounted on the upper surface of the battery-side board 66.

In a state of the contact portion 10 of the signal terminal 8 being not elastically displaced in the connector 2, the upper surface of a back portion of the spring portion 11 is located flush with the upper surface 18 of the housing 15. The dimension of the back portion of the spring portion 11 in the right-left direction is substantially equal to the dimension of the groove 23 of the housing 15 in the right-left direction. Precisely, the dimension of the back portion of the spring portion 11 in the right-left direction is slightly smaller than the dimension of the groove 23 in the right-left direction to such an extent that the contact portion 10 is displaceable. As a result, as shown in FIG. 4, the upper surfaces of the back portions of the spring portions 11 of the plurality of signal terminals 8 are exposed on the upper surface 18 of the housing 15, but the upper surface 18 is flat as a whole with substantially no asperities and gaps. With this configuration, when the connector 2 is surface-mounted on the body-side board 64, the connector 2 can be easily sucked by a mounting device using the upper surface 18 of the housing 15. Thus, the connector 2 can be easily surface-mounted on the body-side board 64.

### [Connection between Connectors]

As shown in FIG. 1, in the electric and electronic equipment 61, the body-side board 64 on which the connector 2 is mounted is attached to the body 62 such that the upper surface of the body-side board 64 faces upward in FIG. 1. Thus, the connector 2 is disposed such that the upper surface 18 of the housing 15 of the connector 2 faces upward in FIG. 1. Meanwhile, the battery-side board 66 on which the partner connector 31 is mounted is attached to the battery 65 such that the upper surface of the battery-side board 66 faces downward in FIG. 1. Thus, the partner connector 31 is disposed such that the upper surface 49 of the housing 46 of the partner connector 31 faces downward in FIG. 1. When the positions of the connector 2 and the partner connector 31 in the up-down direction are coincident with each other, the connector 2 and the partner connector 31 are disposed such that the front surface 16 of the housing 15 of the connector 2 and the front surface 47 of the housing 46 of the partner connector 31 face each other.

When the battery 65 is attached to the body 62, the user holds the battery 65 with one’s hand, and sets the position of the battery 65 such that when the body 62 is viewed from above in FIG. 1, the battery 65 precisely overlaps with the battery attachment recess 63 and the lower surface of the battery 65 is parallel with the bottom surface of the battery attachment recess 63. Thereafter, the user moves the battery 65 downward in FIG. 1 and fits the battery 65 into the battery attachment recess 63 while maintaining the state of the lower surface of the battery 65 being parallel with the bottom surface of the battery attachment recess 63.

At this time, the partner connector 31 moves downward in FIG. 1 together with the battery 65, and at the same time when the battery 65 enters the battery attachment recess 63, the contact portion 5 of each power terminal 3 of the connector 2 enters a corresponding one of the recesses 53 of the housing 46 of the partner connector 31 through the opening of such a recess 53 in the upper surface 49 of the housing 46. Then, the contact portion 5 of each power terminal 3 of the connector 2 enters between the pair of first contact pieces 34 and between the pair of second contact pieces 36 of a corresponding one of the power terminals 32 of the partner connector 31. Then, the contact portion 5 of each power terminal 3 of the connector 2 contacts the contact point portions 38 of the pair of first contact pieces 34 of a corresponding one of the power terminals 32 of the partner connector 31 and the contact point portions 39 of the pair of second contact pieces 36 of the corresponding one of the power terminals 32 of the partner connector 31.

At the substantially same time when the contact portion 5 of each power terminal 3 of the connector 2 enters a corresponding one of the recesses 53 of the partner connector 31, each signal terminal 41 of the partner connector 31 contacts, from above in FIG. 1, a portion of the contact portion 10 of a corresponding one of the signal terminals 8 of the connector 2 protruding forward of the front surface 16 of the housing 15. Then, as the partner connector 31 moves downward in FIG. 1, each signal terminal 41 of the partner connector 31 presses the contact portion 10 of a corresponding one of the signal terminals 8 of the connector 2. Accordingly, the contact portion 10 of each signal terminal 8 of the connector 2 is elastically displaced so as to enter deep in a corresponding one of the grooves 23 of the housing 15 of the connector 2. Then, the contact point portion 12 of each signal terminal 8 of the connector 2 contacts the contact portion 43 of a corresponding one of the signal terminals 41 of the partner connector 31.

### [Another Method of Connecting Connectors]

When the connector 2 and the partner connector 31 according to the first embodiment are connected to each other, the connector 2 and the partner connector 31 are connected by being moved to each other in the up-down direction. Specifically, as shown in FIG. 2, the positions of the connector 2 and the partner connector 31 are set such that the upper surface 18 of the housing 15 of the connector 2 faces upward in FIG. 2, the upper surface 49 of the housing 46 of the partner connector 31 faces downward in FIG. 2, and the upper surface of the contact portion 5 of each power terminal 3 of the connector 2 faces the opening of a corresponding one of the recesses 53 of the housing 46 of the partner connector 31 in the upper surface 49 of the housing 46. Then, for example, the partner connector 31 is moved downward (in the direction of an arrow P) in FIG. 2 toward the connector 2, and is then connected to the connector 2.

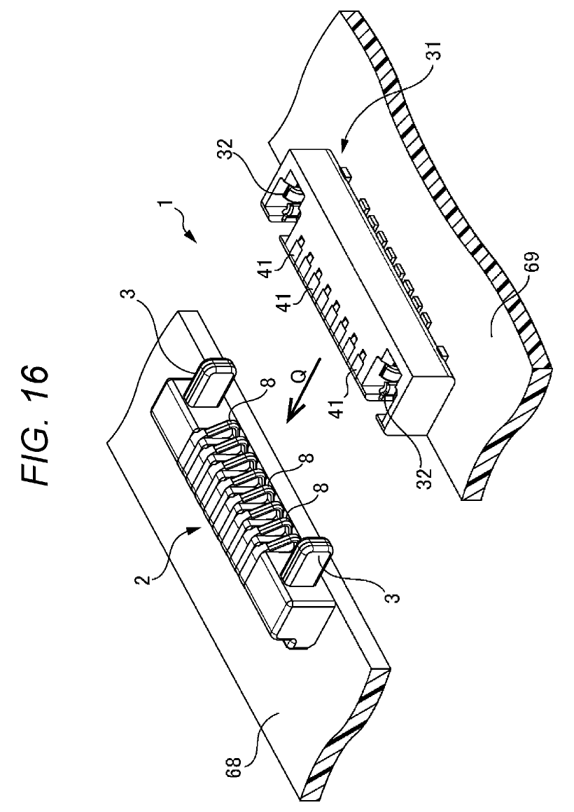

However, in a case where the connector 2 and the partner connector 31 according to the first embodiment are applied to another piece of electric and electronic equipment different from the electric and electronic equipment 61 shown in FIG. 1, the connector 2 and the partner connector 31 can be connected by being moved to each other in the front-back direction. Specifically, as shown in FIG. 16, the positions of the connector 2 and the partner connector 31 are set such that the upper surface 18 of the housing 15 of the connector 2 faces upward in FIG. 16, the upper surface 49 of the housing 46 of the partner connector 31 faces upward in FIG. 16, and the front surface of the contact portion 5 of each power terminal 3 of the connector 2 faces the opening of a corresponding one of the recesses 53 of the housing 46 of the partner connector 31 in the front surface 47 of the housing 46. Then, for example, the partner connector 31 may be moved forward (in the direction of an arrow Q) in FIG. 16 toward the connector 2, and be connected to the connector 2. Note that in FIG. 16, the connector 2 is mounted on a body-side board 68 of the other piece of electric and electronic equipment, and the partner connector 31 is mounted on a battery-side board 69 of a battery used for the other piece of electric and electronic equipment.

### [Function of Correcting Misalignment of Connectors]

The connector 2 and the partner connector 31 according to the first embodiment have a function (misalignment correction function) of correcting misalignment in the right-left direction between the connector 2 and the partner connector 31 upon connection between the connector 2 and the partner connector 31.

As shown in FIG. 2, when the connector 2 and the partner connector 31 are connected by being moved to each other in the up-down direction, the positions of the connector 2 and the partner connector 31 are set such that the contact portion 5 of each power terminal 3 of the connector 2 faces a corresponding one of the recesses 53 of the housing 46 of the partner connector 31 in the up-down direction. Then, for example, by moving the partner connector 31 downward, the partner connector 31 is moved to the connector 2. At this time, in some cases, the partner connector 31 may be misaligned in the right-left direction from the connector 2. As shown in FIG. 16, when the connector 2 and the partner connector 31 are connected by being moved to each other in the front-back direction, the positions of the connector 2 and the partner connector 31 are set such that the contact portion 5 of each power terminal 3 of the connector 2 faces a corresponding one of the recesses 53 of the housing 46 of the partner connector 31 in the front-back direction. Then, for example, by moving the partner connector 31 forward, the partner connector 31 is moved to the connector 2. At this time, in some cases, the partner connector 31 may be misaligned in the right-left direction from the connector 2. According to the misalignment correction function of the connector 2 and the partner connector 31, the misalignment of the connector 2 and the partner connector 31 in the right-left direction can be corrected both when the connector 2 and the partner connector 31 are connected by being moved to each other in the up-down direction and when the connector 2 and the partner connector 31 are connected by being moved to each other in the front-back direction.

First, the correction of the misalignment of the connector 2 and the partner connector 31 in the right-left direction when the connector 2 and the partner connector 31 are connected by being moved to each other in the up-down direction will be described.

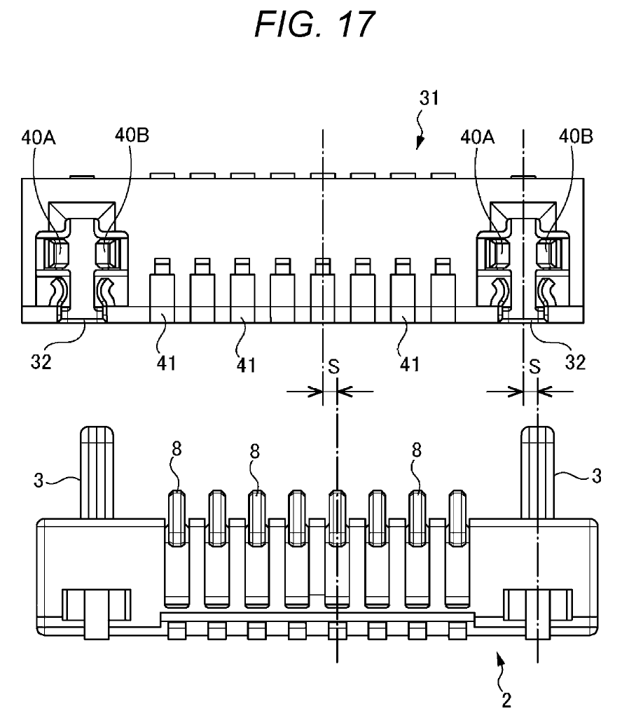

FIG. 17 shows a state in which the partner connector 31 is misaligned to the left side from the connector 2 when the connector 2 and the partner connector 31 are connected by being moved to each other in the up-down direction. In FIG. 17, in a case where the amount S of the leftward misalignment of the partner connector 31 from the connector 2 is within a predetermined misalignment correctable range, the misalignment correction function of the connector 2 and the partner connector 31 can correct the leftward misalignment of the partner connector 31 from the connector 2 and eliminate such misalignment. Although not shown, in a case where the amount of rightward misalignment of the partner connector 31 from the connector 2 is within a predetermined misalignment correctable range, the misalignment correction function of the connector 2 and the partner connector 31 can correct the rightward misalignment of the partner connector 31 from the connector 2, and can eliminate such misalignment.

The misalignment of the connector 2 and the partner connector 31 in the right-left direction when the connector 2 and the partner connector 31 are connected by being moved to each other in the up-down direction is corrected mainly by the chamfered portions 6A, 6B (see FIG. 8D) formed at the upper left corner portion and the upper right corner portion of the contact portion 5 of each power terminal 3 of the connector 2 and the guide portions 40A, 40B (see FIG. 14C) formed at the upper end portions of the pair of first contact pieces 34 of each power terminal 32 of the partner connector 31.

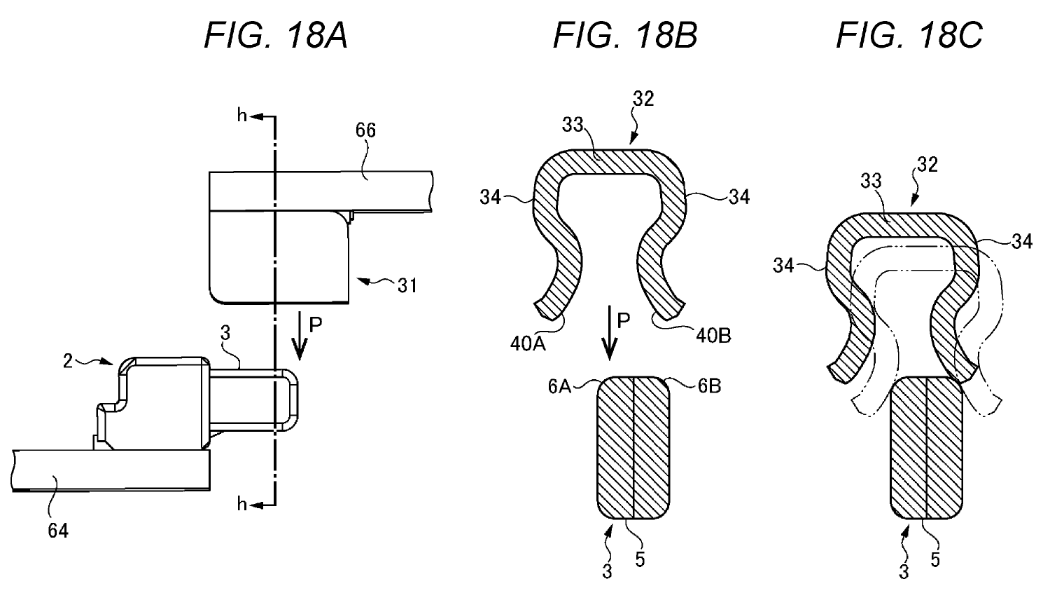

FIG. 18A shows the states of the connector 2 and the partner connector 31 when the connector 2 and the partner connector 31 are connected by being moved to each other in the up-down direction, as viewed from the left side. FIGS. 18B and 18C show the states of the section of the contact portion 5 of the power terminal 3 of the connector 2 and the sections of the pair of first contact pieces 34 of the power terminal 32 of the partner connector 31 taken along cut line h-h in FIG. 18A, as viewed from the left side in FIG. 18A.

For example, it is assumed that when the partner connector 31 is moved downward (in the direction of an arrow P in FIG. 18A) to the connector 2 in order to connect the connector 2 and the partner connector 31 to each other, the partner connector 31 is misaligned leftward from the connector 2 and the amount of such misalignment is within the predetermined misalignment correctable range. In this case, in a course of the partner connector 31 moving to the connector 2, the guide portion 40B formed at the upper end portion of the right first contact piece 34 of each power terminal 32 of the partner connector 31 moves to the chamfered portion 6B formed at the upper right corner portion of the contact portion 5 of a corresponding one of the power terminals 3 of the connector 2, as shown in FIG. 18B. Then, as shown in FIG. 18C, the guide portion 40B contacts the chamfered portion 6B. Accordingly, the pair of first contact pieces 34 of each power terminal 32 of the partner connector 31 moves rightward, and the positions of the pair of first contact pieces 34 are brought to those indicated by a dash-dot-dot line in FIG. 18C. That is, the contact portion 5 of the power terminal 3 of the connector 2 is guided to between the pair of first contact pieces 34 by the guide portions 40B of the first contact pieces 34 of the power terminal 32 of the partner connector 31. As a result, the positions of the pair of first contact pieces 34 and the contact portion 5 in the right-left direction precisely become coincident with each other. Then, as the pair of first contact pieces 34 moves, the partner connector 31 moves rightward of the connector 2. As a result, the leftward misalignment of the partner connector 31 from the connector 2 is eliminated.

Next, the correction of the misalignment of the connector 2 and the partner connector 31 in the right-left direction when the connector 2 and the partner connector 31 are connected by being moved to each other in the front-back direction will be described.

The misalignment of the connector 2 and the partner connector 31 in the right-left direction when the connector 2 and the partner connector 31 are connected by being moved to each other in the front-back direction is corrected mainly by the chamfered portions 6E, 6F formed at the front left corner portion and the front right corner portion of the contact portion 5 of each power terminal 3 of the connector 2, the guide portions 40C, 40D formed at the front right corner portion of the left extending portion 35 and the front left corner portion of the right extending portion 35 of each power terminal 32 of the partner connector 31, and the guide portions 40E, 40F formed at the front end portions of the pair of second contact pieces 36 of each power terminal 32 of the partner connector 31.

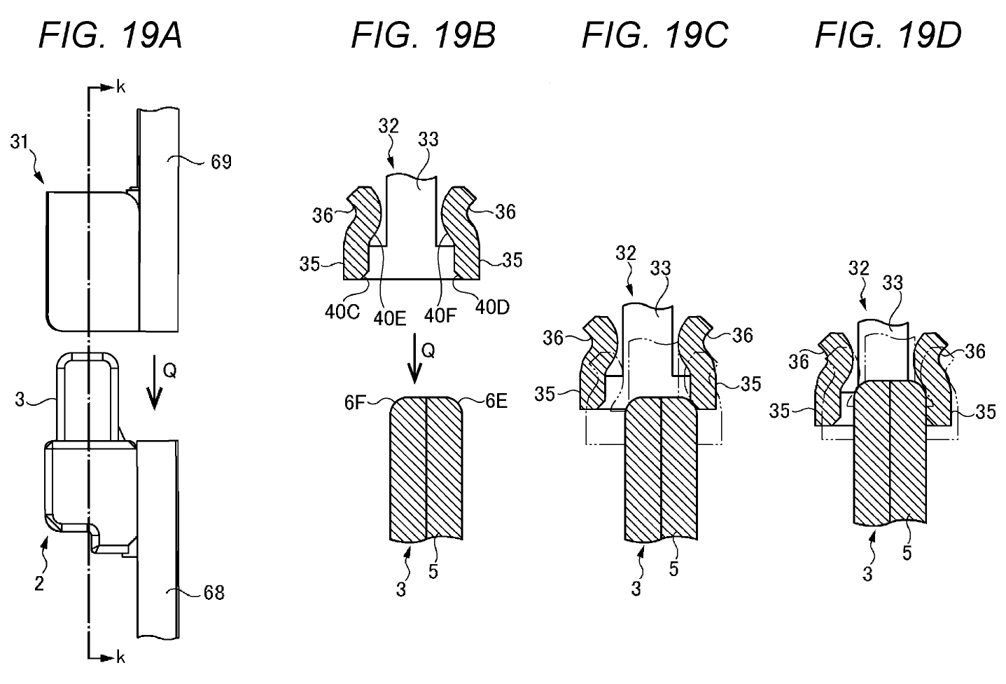

FIG. 19A shows the states of the connector 2 and the partner connector 31 when the connector 2 and the partner connector 31 are connected by being moved to each other in the front-back direction, as viewed from the right side of the partner connector 31. FIGS. 19B and 19C show the states of the section of the contact portion 5 of the power terminal 3 of the connector 2 and the section of the front portion of the power terminal 32 of the partner connector 31 taken along cut line k-k in FIG. 19A, as viewed from the left side in FIG. 19A.

For example, it is assumed that when the partner connector 31 is moved forward (in the direction of an arrow Q in FIG. 19A) to the connector 2 in order to connect the connector 2 and the partner connector 31 to each other, the partner connector 31 is misaligned leftward in FIG. 19B from the connector 2 and the amount of such misalignment is within the predetermined misalignment correctable range. In this case, in a course of the partner connector 31 moving to the connector 2, the guide portion 40D formed at the front left corner portion of the right extending portion 35 of each power terminal 32 of the partner connector 31 moves to the chamfered portion 6E formed at the front left corner portion (front right corner portion in FIG. 19B) of the contact portion 5 of a corresponding one of the power terminals 3 of the connector 2, as shown in FIG. 19B. Then, as shown in FIG. 19C, the guide portion 40D contacts the chamfered portion 6E. Accordingly, each power terminal 32 of the partner connector 31 moves rightward in FIG. 19C, and the position of each power terminal 32 is brought to that indicated by a dash-dot-dot line in FIG. 19C. That is, the contact portion 5 of the power terminal 3 of the connector 2 is guided to between the pair of extending portions 35 by the guide portions 40D of the extending portions 35 of the power terminal 32 of the partner connector 31. Subsequently, when the partner connector 31 further moves to the connector 2, the guide portion 40F formed at the front end portion of the right second contact piece 36 of each power terminal 32 of the partner connector 31 contacts the chamfered portion 6E formed at the front left corner portion (front right corner portion in FIG. 19D) of the contact portion 5 of a corresponding one of the power terminals 3 of the connector 2, as shown in FIG. 19D. Accordingly, each power terminal 32 of the partner connector 31 moves rightward in FIG. 19D, and the position of each power terminal 32 is brought to a position indicated by a dash-dot-dot line in FIG. 19D. That is, the contact portion 5 of the power terminal 3 of the connector 2 is guided to between the pair of second contact pieces 36 by the guide portions 40F of the second contact pieces 36 of the power terminal 32 of the partner connector 31. As a result, the positions of the pair of second contact pieces 36 and the contact portion 5 in the right-left direction precisely become coincident with each other. Then, as each power terminal 32 of the partner connector 31 moves as described above, the partner connector 31 moves rightward of the connector 2. As a result, the leftward misalignment of the partner connector 31 from the connector 2 is eliminated.

Since the misalignment of the connector 2 and the partner connector 31 in the right-left direction is eliminated, not only the positions of the two power terminals 3 of the connector 2 in the right-left direction and the positions of the two power terminals 32 of the partner connector 31 in the right-left direction become coincident with each other, but also the positions of the plurality of signal terminals 8 of the connector 2 in the right-left direction and the positions of the plurality of signal terminals 41 of the partner connector 31 in the right-left direction also become coincident with each other. Thus, the contact portion 5 of each power terminal 3 of the connector 2 reliably contacts the contact point portions 38 of the pair of first contact pieces 34 of a corresponding one of the power terminals 32 of the partner connector 31 and the contact point portions 39 of the pair of second contact pieces 36 of the corresponding one of the power terminals 32, and the contact point portion 12 of the contact portion 10 of each signal terminal 8 of the connector 2 reliably contacts the contact portion 43 of a corresponding one of the signal terminals 41 of the partner connector 31.

### (Second Embodiment)

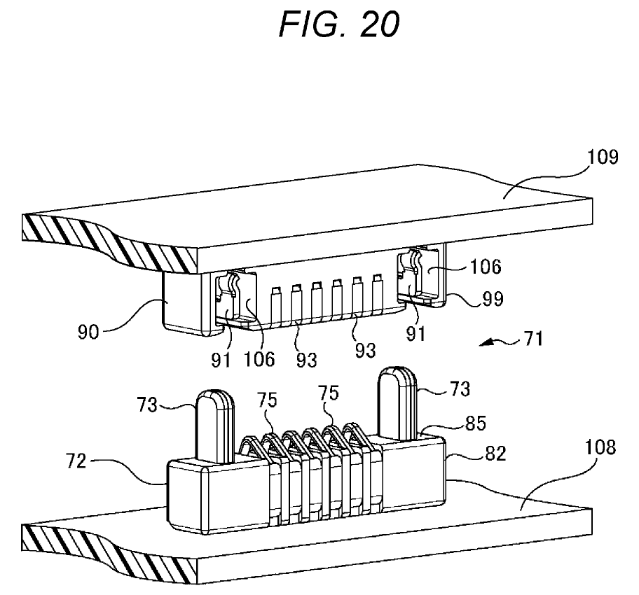

FIG. 20 shows a connector device 71 of a second embodiment of the present disclosure. As shown in FIG. 20, the connector device 71 includes a connector 72 of the second embodiment and a partner connector 90 of the second embodiment. As a result of comparison between the connector device 1 of the first embodiment above and the connector device 71 of the second embodiment, these connector devices are different from each other in the protruding direction of each terminal of the connector. That is, in the connector device 1 of the first embodiment of the present disclosure, the power terminal 3 and the signal terminal 8 of the connector 2 protrude forward of the front surface 16 of the housing 15, and the protruding direction of the power terminal 3 and the signal terminal 8 is parallel with the upper surface of the body-side board 64. On the other hand, in the connector device 71 of the second embodiment of the present disclosure, a power terminal 73 and a signal terminal 75 of the connector 72 protrude upward of the upper surface 85 of a housing 82, and the protruding direction of the power terminal 73 and the signal terminal 75 is perpendicular to the upper surface of a body-side board 108.

The connector 72 is surface-mounted on the body-side board 108 of electric and electronic equipment different from the electric and electronic equipment 61 shown in FIG. 1. The partner connector 90 is surface-mounted on a battery-side board 109 of a battery different from the battery 65 shown in FIG. 1. For example, as shown in FIG. 20, the partner connector 90 is connected to the connector 72 with flipped upside down.

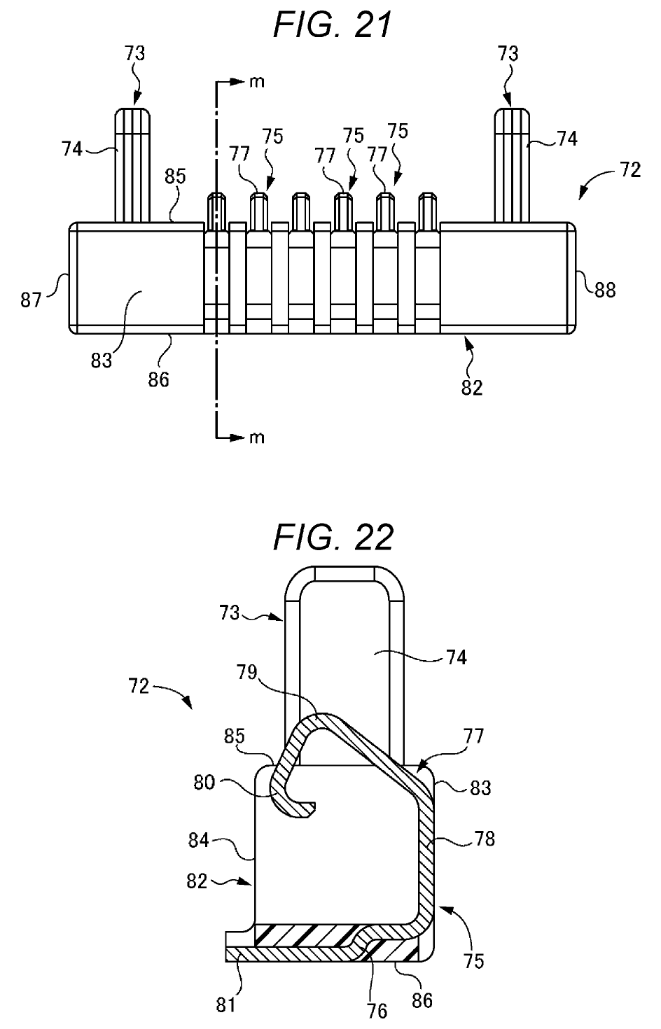

FIG. 21 shows the state of the connector 72 of the second embodiment of the present disclosure as viewed from the front side. In FIG. 21, the connector 72 includes two power terminals 73, a plurality (for example, six) of signal terminals 75, and the housing 82 holding the power terminals 73 and the signal terminals 75. Note that the power terminal 73 is a specific example of a “first terminal”, the signal terminal 75 is a specific example of a “second terminal”, and the housing 82 is a specific example of a “terminal holder”.

The housing 82 of the connector 72 is formed in a rectangular parallelepiped shape as a whole from an insulating material such as resin, for example, and has a front surface 83, a back surface 84, the upper surface 85, a lower surface 86, a left surface 87, and a right surface 88. An intermediate portion of the housing 82 in the right-left direction is formed with a plurality of grooves for displaceably disposing contact portions 77 of the plurality of signal terminals 75. Each groove extends downward from the upper surface 85 of the housing 82 to a lower portion of the housing 82, and extends from the front surface 83 to the back surface 84 of the housing 82. As a result, each groove is continuously opened from an upper portion of the front surface 83 of the housing 82 to an upper portion of the back surface 84 through the upper surface 85. The housing 82 is integrated with a lower portion of each power terminal 73 and a lower portion of each signal terminal 75 by insert molding.

In the connector 72, the two power terminals 73 are disposed at right and left portions of the housing 82. The configuration of each power terminal 73 itself is the same as the configuration of the power terminal 3 in the first embodiment. A contact portion 74 of each power terminal 73 is formed so as not to elastically deform, similarly to the contact portion 5 of the power terminal 3 in the first embodiment. On the other hand, unlike the power terminal 3 in the first embodiment, each power terminal 73 extends in the up-down direction, and the contact portion 74 of each power terminal 73 protrudes upward of the upper surface 85 of the housing 82. Note that the contact portion 74 is a specific example of a “first contact portion”.

In the connector 72, the plurality of signal terminals 75 is disposed between the two power terminals 73. The plurality of signal terminals 75 is arranged in line and in parallel at equal intervals in the right-left direction from one power terminal 73 to the other power terminal 73. Each signal terminal 75 is a compression terminal or a spring terminal. Similarly to the signal terminal 8 in the first embodiment, each signal terminal 75 is formed in such a manner that a thin band-shaped metal piece obtained by punching a metal plate member is bent.

FIG. 22 shows the state of the section of the connector 72 taken along cut line m-m in FIG. 21, as viewed from the left side. As shown in FIG. 22, each signal terminal 75 has a fixing portion 76, the contact portion 77, and a board connection portion 81, and the contact portion 77 has a spring portion 78, a contact point portion 79, and a curved portion 80. As a result of comparison between the signal terminal 75 in FIG. 22 and the signal terminal 8 of the first embodiment in FIG. 7, the signal terminal 75 is different from the signal terminal 8 in the direction thereof as a whole, and the shape of the board connection portion 81 of the signal terminal 75 is different from the shape of the board connection portion 14 of the signal terminal 8. Except for these points, the signal terminal 75 is substantially similar to the signal terminal 8. Note that the contact portion 77 is a specific example of a “second contact portion”.

In the connector 72, the fixing portion 76 of each signal terminal 75 is embedded in a lower portion of the housing 82, and is fixed to the housing 82. The contact portion 77 of each signal terminal 75 is elastically displaceably formed. Moreover, the contact portion 77 of each signal terminal 75 is displaceably located in the groove of the housing 82. That is, in a state of the contact portion 77 being not elastically displaced, an upper portion of the spring portion 78 and the contact point portion 79 protrude from the groove, the upper portion of the spring portion 78 protrudes upward of the upper surface 85 of the housing 82, and the contact point portion 79 is positioned higher than the upper surface 85 of the housing 82.

When the connector 72 and the partner connector 90 are connected to each other, a portion of the contact portion 77 protruding upward of the groove of the housing 82 is pressed downward by a signal terminal 93 of the partner connector 90, the contact portion 77 is elastically displaced, a large portion of the contact portion 77 enters the groove, and the contact point portion 79 moves downward. The board connection portion 81 extends backward of a back end portion of the fixing portion 76, and is exposed to the outside of the housing 82 from a lower back portion of the housing 82. Moreover, the board connection portion 81 is located such that the lower surface thereof is flush with the lower surface 86 of the housing 82.

In the connector 72, the cross-sectional area of each portion of the power terminal 73 is greater than the cross-sectional area of each portion of the signal terminal 75, and therefore, the current capacity of the power terminal 73 is greater than the current capacity of the signal terminal 75. Thus, according to the connector 72, a power-supply current having a great value or a charging current having a great value can be applied similarly to the connector 2 of the first embodiment.

In the connector 72, each signal terminal 75 has a great cross-sectional area of each portion, and is disposed between the two power terminals 73 having a high strength. With this configuration, contact of an external object with the signal terminal 75 can be reduced by the two power terminals 73, and the durability of the connector 72 can be enhanced, similarly to the connector 2 of the first embodiment.

In the connector 72, the protruding amount of the contact portion 77 of each power terminal 73 from the housing 82 is greater than the protruding amount of each signal terminal 75 from the housing 82. Thus, similarly to the connector 2 of the first embodiment, an effect of reducing the contact of the external object with the signal terminal 75 by the two power terminals 73 can be enhanced, and the durability of the connector 2 can be further enhanced.

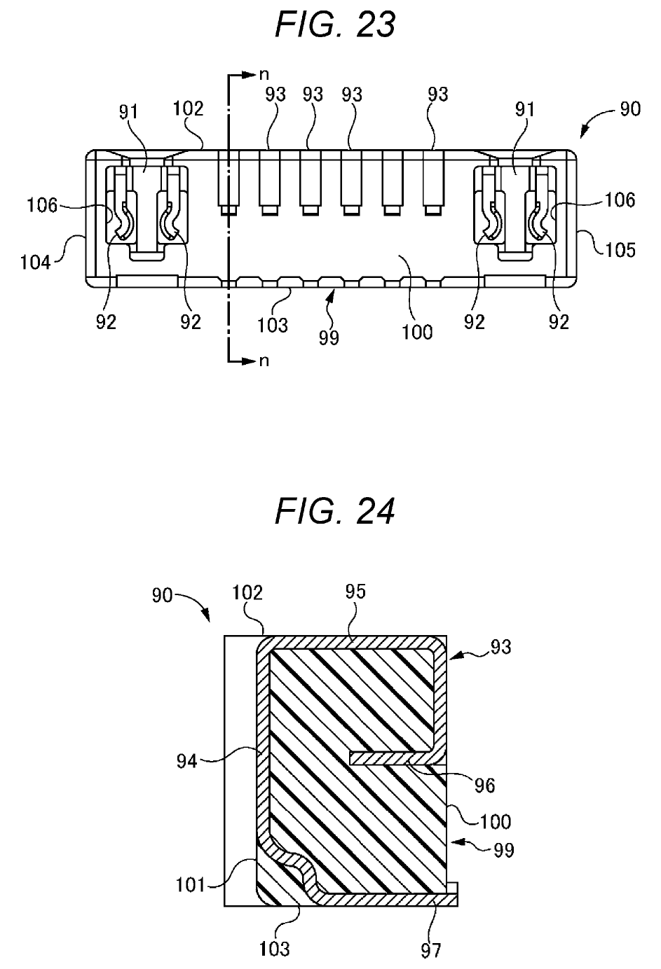

FIG. 23 shows the state of the partner connector 90 of the second embodiment of the present disclosure as viewed from the front side. In FIG. 23, the partner connector 90 includes two power terminals 91, a plurality (for example, six) of signal terminals 93, and a housing 99 holding the power terminals 91 and the signal terminals 93. Note that the power terminal 91 is a specific example of a “first partner terminal”, the signal terminal 93 is a specific example of a “second partner terminal”, and the housing 99 is a specific example of a “partner terminal holder”.

The housing 99 of the partner connector 90 is formed in a rectangular parallelepiped shape as a whole from an insulating material such as resin, for example, and has a front surface 100, a back surface 101, an upper surface 102, a lower surface 103, a left surface 104, and a right surface 105. The housing 99 is provided with two recesses 106. One recess 106 is located in a left portion of the housing 99, and the other recess 106 is located in a right portion of the housing 99. Each recess 106 is opened continuously to the upper surface 102 and the front surface 100 of the housing 99. The housing 99 is integrated with part of each power terminal 91 and each signal terminal 93 by insert molding.

In the partner connector 90, the two power terminals 91 are each disposed in the two recesses 106 of the housing 82. The configuration of each power terminal 91 itself is the substantially same as a configuration obtained by omitting the pair of first contact pieces 34 from the power terminal 32 of the first embodiment. Each power terminal 91 has a pair of contact pieces 92. The pair of contact pieces 92 is substantially similar to the pair of second contact pieces 36 of the power terminal 32 of the first embodiment. Note that the pair of contact pieces 92 is a specific example of a “first partner contact portion”.

In the partner connector 90, the plurality of signal terminals 93 is disposed between the two recesses 106 formed in the housing 99. The plurality of signal terminals 93 is arranged in line and in parallel at equal intervals in the right-left direction from one recess 106 to the other recess 106. The arrangement of the plurality of signal terminals 93 is set corresponding to the arrangement of the plurality of signal terminals 75 of the connector 72. Similarly to the signal terminal 41 in the first embodiment, each signal terminal 93 is formed in such a manner that a thin band-shaped metal piece obtained by punching a metal plate member is bent.

FIG. 24 shows the state of the section of the partner connector 90 taken along cut line n-n in FIG. 23, as viewed from the left side. As shown in FIG. 24, each signal terminal 93 has a base portion 94, a contact portion 95, a bent portion 96, and a board connection portion 97. As a result of comparison between the signal terminal 93 in FIG. 24 and the signal terminal 41 of the first embodiment in FIG. 13, the signal terminal 93 is different from the signal terminal 41 in the direction thereof as a whole, and the shape of the board connection portion 81 of the signal terminal 93 is different from the shape of the board connection portion 45 of the signal terminal 41. Except for these points, the signal terminal 75 is substantially similar to the signal terminal 41. Note that the contact portion 95 is a specific example of a “second partner contact portion”.

In each signal terminal 93 of the partner connector 90, the back surface of the base portion 94, the upper surface of the contact portion 95, and the front surface of an upper portion of the bent portion 96 are exposed to the outside from the housing 99. The back surface of the base portion 94 is flush with the back surface 101 of the housing 99, the upper surface of the contact portion 95 is flush with the upper surface 102 of the housing 99, and the front surface of the upper portion of the bent portion 96 is flush with the front surface 100 of the housing 99. A portion of each signal terminal 93 other than the back surface of the base portion 94, the upper surface of the contact portion 95, the front surface of the upper portion of the bent portion 96, and the board connection portion 97 is embedded in the housing 99, and is fixed to the housing 99. The board connection portion 97 of each signal terminal 93 is positioned in a lower portion of the housing 99. The board connection portion 97 extends forward of a lower end portion of the base portion 94, and the lower surface and a front end portion thereof are exposed to the outside from the housing 99. Moreover, the board connection portion 97 is located such that the lower surface thereof is flush with the lower surface 103 of the housing 99.

In the partner connector 90, the cross-sectional area of each portion of the power terminal 91 is greater than the cross-sectional area of each portion of the signal terminal 93, and therefore, the current capacity of the power terminal 91 is greater than the current capacity of the signal terminal 93. Thus, according to the partner connector 90, a power-supply current having a great value or a charging current having a great value can be applied similarly to the partner connector 31 of the first embodiment.

Note that for the connector 2, the connector 72, the partner connector 31, and the partner connector 90 of each embodiment above, the number of signal terminals is not limited. The number of signal terminals of the connector and the number of signal terminals of the partner connector may be one.

In each embodiment above, the case where the connector, the partner connector, and the connector device according to the present disclosure are used as the connector, the partner connector, and the connector device for connecting the body-side and battery-side boards of the electric and electronic equipment has been described as an example, but the present disclosure is not limited thereto. The connector, the partner connector, and the connector device according to the present disclosure can be broadly used as a connector, a partner connector, and a connector device for connecting boards regardless of use application.

In each embodiment above, the first terminal of the connector of the present disclosure is the power terminal, and the second terminal of the connector of the present disclosure is the signal terminal. However, the present disclosure is not limited thereto. The first terminal of the connector of the present disclosure can be used as a terminal for applying a current having a great value, other than the power terminal, and the second terminal of the connector of the present disclosure can be used as a terminal for applying a current having a small value, other than the signal terminal. The same also applies to the first partner terminal and the second partner terminal of the partner connector.

The present disclosure can be modified as necessary without departing from the gist or idea of the present disclosure, which can be read from the claims and the entire specification, and connectors, partner connectors, and connector devices of these modifications are also included in the technical idea of the present disclosure.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector comprising:
two first terminals;
a second terminal disposed between the two first terminals; and
a terminal holder holding the first terminals and the second terminal,
wherein each first terminal has a first contact portion,
the first contact portion protrudes in one direction from the terminal holder, and is formed so as not to elastically displace,
the second terminal has a second contact portion, and
the second contact portion protrudes in the one direction from the terminal holder, and is formed elastically displaceably in a direction opposite to the one direction.

2. The connector according to claim 1, wherein
a protruding amount of the first contact portion from the terminal holder is greater than a protruding amount of the second contact portion from the terminal holder.

3. The connector according to claim 1, wherein
a cross-sectional area of the first contact portion is greater than a cross-sectional area of the second contact portion.

4. The connector according to claim 1, wherein
the second terminal includes a plurality of second terminals, and
the plurality of second terminals is arranged in line from one of the two first terminals to the other first terminal.

5. The connector according to claim 1, wherein
the first contact portion of each first terminal is configured to contact a first partner terminal of a partner connector to be connected to the connector, and
the second contact portion of the second terminal is configured to elastically displace in the direction opposite to the one direction by contacting a second partner terminal of the partner connector.

6. A partner connector to be connected to a connector,
the connector including two first terminals, a second terminal disposed between the two first terminals, and a terminal holder holding the first terminals and the second terminal, each first terminal protruding in one direction from the terminal holder and being formed so as not to elastically displace, and the second terminal protruding in the one direction from the terminal holder and being formed elastically displaceably in a direction opposite to the one direction, the partner connector comprising:
two first partner terminals;
a second partner terminal; and
a partner terminal holder holding the first partner terminals and the second partner terminal,
wherein the partner terminal holder has two recesses provided apart from each other,
the first partner terminals are each disposed in the two recesses,
each first partner terminal has a first partner contact portion configured to contact a corresponding one of the first terminals inserted into the recesses,
the second partner terminal is disposed between the two recesses, and
the second partner terminal has a second partner contact portion configured to contact the second terminal while pressing and elastically displacing the second terminal.

7. The partner connector according to claim 6, wherein
each first partner terminal has a base portion extending in a front-back direction,
the first partner contact portion has a pair of first contact pieces, a pair of extending portions, and a pair of second contact pieces,
the pair of first contact pieces extends upward of right and left end portions of a back portion of the base portion, and contacts a corresponding one of the first terminals inserted into the recesses while sandwiching the corresponding one of the first terminals,
the pair of extending portions extends upward of right and left end portions of a front portion of the base portion,
the pair of second contact pieces extends backward of the pair of extending portions, and contacts a corresponding one of the first terminals inserted into the recesses while sandwiching the corresponding one of the first terminals, and
the pair of first contact pieces is elastically displaceably formed such that upper end portions thereof are opened with lower end portions thereof as a base point, and the pair of second contact pieces is elastically displaceably formed such that back end portions thereof are opened with front end portions thereof as a base point.

8. The partner connector according to claim 7, wherein
an upper end portion of each of the pair of first contact pieces is provided with a first guide portion,
the first guide portion is configured to guide a corresponding one of the first terminals inserted into the recesses from thereabove to between the pair of first contact pieces,
the front end portion of each of the pair of second contact pieces is provided with a second guide portion, and
the second guide portion is configured to guide a corresponding one of the first terminals inserted into the recesses from a front thereof to between the pair of second contact pieces.

9. A connector device comprising:
a connector; and
a partner connector to be connected to the connector,
wherein the connector includes two first terminals, a second terminal disposed between the two first terminals, and a terminal holder holding the first terminals and the second terminal,
each first terminal has a first contact portion,
the first contact portion protrudes in one direction from the terminal holder, is formed so as not to elastically displace, and is configured to contact a first partner terminal of the partner connector,
the second terminal has a second contact portion,
the second contact portion protrudes in the one direction from the terminal holder, is formed elastically displaceably in a direction opposite to the one direction, and by being pressed by a second partner terminal of the partner connector, contacts the second partner terminal while elastically displacing in the direction opposite to the one direction,
the partner connector includes two first partner terminals as the first partner terminal, the second partner terminal, and a partner terminal holder holding the first partner terminals and the second partner terminal,
the partner terminal holder has two recesses provided apart from each other,
the first partner terminals are each disposed in the two recesses,
each first partner terminal has a first partner contact portion configured to contact the first contact portion inserted into a corresponding one of the recesses,
the second partner terminal is disposed between the two recesses, and
the second partner terminal has a second partner contact portion configured to contact the second contact portion while pressing and elastically displacing the second contact portion.
